(19) United States
(12) Patent Application Publication
(10) Pub. No.: US 2013/0071013 A1
(43) Pub. Date: Mar. 21, 2013

(54) VIDEO PROCESSING DEVICE, VIDEO PROCESSING METHOD, PROGRAM

(71) Applicants: Shinsuke Ogata, Osaka (JP); Kinichi Motosaka, Osaka (JP); Akihiro Miyazaki, Osaka (JP)

(72) Inventors: Shinsuke Ogata, Osaka (JP); Kinichi Motosaka, Osaka (JP); Akihiro Miyazaki, Osaka (JP)

(21) Appl. No.: 13/700,543

(22) PCT Filed: Feb. 23, 2012
(86) PCT No.: PCT/JP2012/001259

§ 371 Date: Nov. 28, 2012

(30) Foreign Application Priority Data
Mar. 1, 2011 (JP) 2011-044081

(51) Int. Cl. G06K 9/46

(52) U.S. Cl. 382/154

(57) ABSTRACT

A feature point extraction unit 901 extracts a feature point suitable for calculation of parallax from pixels constituting a region targeted for calculation of parallax and pixels located near the targeted region. A first parallax calculation unit 902 calculates parallax for the extracted feature point by performing a search for corresponding points. A second parallax calculation unit 903 calculates parallax for each of the pixels constituting the targeted region based on the parallax calculated by the first parallax calculation unit 902 for the extracted feature point.

### TECHNICAL FIELD

The present invention relates to stereoscopic video processing technology, and in particular to technology for calculating parallax of stereoscopic video images.

### BACKGROUND ART

In recent years, stereoscopic video processing technology using parallax video images has been gaining attention and studied from many perspectives. Parallax refers to an offset amount (a shift amount) in a horizontal direction between corresponding pixels in a set of a left-view video image and a right-view video image. By presenting corresponding parallax video images to the respective eyes, stereoscopic viewing is implemented.

One example of the stereoscopic video processing technology is technology for performing overlaying with respect to stereoscopic video images. In this technology, an object, such as graphics, a symbol, and a letter, is overlaid on each of left-view image data and light-view image data so that the offset amount is provided to the object. With this technology, various types of additional information can sterically be added to a stereoscopic video image.

In the above-mentioned technology, since an object is overlaid in a depth direction, it is necessary to consider the offset amounts for an object-overlaying region on a stereoscopic video image in which the object is to be overlaid. For example, when the offset amounts for the object-overlaying region on the stereoscopic video image are larger than the offset amount provided to the object, the stereoscopic video image appears to project forward from the object and the object appears to be buried within the stereoscopic video image. This makes it difficult to fully recognize the overlaid object.

To avoid such a situation, Patent Literature 1 discloses technology for calculating the offset amounts for the object-overlaying region on the stereoscopic video image, and determining the offset amount larger than a maximum value of the calculated offset amounts as the offset amount provided to the object. Patent Literature 2 discloses technology for, in a case where stereoscopic display is performed by providing the offset amount to each of a plurality of 2D objects, determining whether or not the objects overlap one another, and, when determining affirmatively, adjusting positions and sizes of the objects, the offset amount provided to each of the objects, and the like.

### CITATION LIST

### Patent Literature

### [Patent Literature 1]

Japanese Patent Application Publication No. 2010-86228

### [Patent Literature 2]

Japanese Patent Application Publication No. 2005-122501

### SUMMARY OF INVENTION

### Technical Problem

In the technology disclosed in Patent Literature 1, in order to perform overlaying of the object considering the offset amounts for the object-overlaying region on the stereoscopic video image, a search for corresponding points is performed between all pixels constituting the object-overlaying region on left-view video image data and all pixels constituting the object-overlaying region on right-view video image data. The search for corresponding points is performed by calculating a correlation value for each pixel based on a brightness value and the like, and detecting a pixel with the highest correlation value. If such processing is performed for all pixels constituting the object-overlaying region on a stereoscopic video image, an enormous amount of calculation is required. That is to say, in the processing to overlay an object, it takes a long time to calculate the offset amounts for the region targeted for calculation of the offset amount, and thus it is difficult to overlay the object on a stereoscopic video image in real time. Furthermore, in the object-overlaying region on left-view video image data and the object-overlaying region on right-view video image data, there can be many pixels among which there is little difference in brightness and thus in which it is difficult to perform the search for corresponding points. With the technology disclosed in Patent Literature 1, since the search for corresponding points is performed for even a pixel at which it is difficult to accurately perform the search, there may be a case where an erroneous corresponding point is detected and a correct offset amount is not calculated.

Patent Literature 2 discloses technology for, in a case where stereoscopic display is performed by providing the offset amount to each of a plurality of 2D objects, determining whether or not the objects overlap one another. This technology is therefore not applicable to a case where an object is sterically overlaid on a stereoscopic video image whose offset amount is unknown.

The present invention has been conceived in light of the above circumstances, and aims to provide a video processing device capable of calculating the offset amount between corresponding pixels in a set of image data pieces constituting a stereoscopic video image with accuracy.

### Solution to Problem

In order to achieve the above-mentioned aim, a video processing device according to one aspect of the present invention is a video processing device for calculating an offset amount in a horizontal direction between corresponding pixels in a set of main-view data and sub-view data constituting a stereoscopic video image, comprising: a feature point extraction unit configured to limit a search range to a region on the main-view data targeted for calculation of the offset amount and a region near the targeted region, and extract a predetermined number of feature points from the search range, each feature point being a characterizing pixel in the main-view data; a first offset amount calculation unit configured to calculate the offset amount for each of the feature points by performing a search for corresponding feature points in the sub-view data; and a second offset amount calculation unit configured to calculate the offset amount for each of pixels constituting the targeted region by using the offset amount calculated for each of the feature points.

### Advantageous Effects of Invention

If the search for corresponding points is performed for all pixels constituting a stereoscopic video image, an enormous amount of calculation is required. In the present invention, the search for corresponding points is performed only for each of the feature points extracted from the region targeted for calculation of the offset amount (parallax) between corresponding pixels in the set of the main-view data and the sub-view data and the region near the targeted region, and the offset amount for pixels other than the feature points is calculated based on the offset amount for each of the feature points calculated by the search. The amount of calculation required for calculation of the offset amount is therefore greatly reduced. As a result, an object having an appropriate stereoscopic effect is quickly overlaid on a stereoscopic video image in real time.

In a region, within the region targeted for calculation of the offset amount, in which there is little change in brightness, there may be a case where an erroneous corresponding point is detected and a correct offset amount is not calculated. In the present invention, the search for corresponding points is performed only for a feature point, and the offset amount for pixels other than the feature point is calculated based on the offset amount for the feature point. It is therefore possible to calculate the offset amount with accuracy.

Furthermore, in the present invention, a search for a feature point is performed not only in a region targeted for calculation of the offset amount but also in pixels near the targeted region. Even when a sufficient number of feature points are not included in the targeted region, it is possible to calculate the offset amount with accuracy.

### BRIEF DESCRIPTION OF DRAWINGS

FIG. 1 is a block diagram showing an example of the structure of a video processing device 100.

FIG. 2 is a schematic diagram showing the data structure of timing information 201.

FIG. 3 is a schematic diagram showing the data structure of a rendering request queue 106.

FIG. 4 shows an example of the inner structure of a video processing unit 107.

FIG. 5 is a schematic diagram showing the data structure of object parallax information 501.

FIG. 6 is an illustration for explaining generation of an object image.

FIG. 7 is an illustration for explaining overlaying performed by an overlaying unit 405.

FIG. 8 shows stereoscopic viewing of a stereoscopic video image after overlaying is performed by the video processing device 100.

FIG. 9 shows an example of the inner structure of a parallax information generation unit 402.

FIG. 10 is a schematic diagram showing the data structure of search information 1001.

FIG. 11 is an illustration for explaining divided regions.

FIG. 12 shows a data example of divided region information 1002.

FIG. 13 shows a data example of feature point information 1003.

FIG. 14 shows the data structure of sampling point information 1004.

FIG. 15 shows examples of a region on a left-view video image indicated by a parallax mask.

FIG. 16 is an illustration for explaining extraction of a feature point within a region 1501.

FIG. 17 is an illustration showing extraction of a feature point within a divided quadrant 1630.

FIGS. 18A to 18C are illustrations each showing extraction of a feature point within a divided quadrant 1640.

FIG. 19 is an illustration showing calculation of parallax for a feature point.

FIG. 20 shows a region in which calculation of parallax is performed.

FIG. 21 is a flow chart showing an operation of the video processing device 100.

FIG. 22 is a flow chart showing video processing.

FIG. 23 is a flow chart showing calculation of parallax.

FIG. 24 is a block diagram showing an example of the structure of a video processing device 2400.

FIG. 25 is a schematic diagram showing the data structure of a rendering request queue 2402.

FIG. 26 is a block diagram showing an example of the structure of a video processing unit 2403.

FIGS. 27A and 27B are illustrations each showing overlaying of an object performed by the video processing device 2400.

FIG. 28 is an illustration for explaining generation of an object image.

FIG. 29 is a flow chart showing an operation of the video processing unit 2403.

FIG. 30 shows stereoscopic viewing of a stereoscopic video image after overlaying is performed by the video processing device 2400.

FIG. 31 is a block diagram showing an example of the inner structure of a video processing unit 3100 according to Embodiment 3.

FIG. 32 shows a case where image data representing the depth by brightness is stored.

FIG. 33 is a flow chart showing depth information conversion performed by the video processing unit 3100.

FIG. 34 is a block diagram showing an example of the structure of a video processing device 3400 according to Embodiment 4.

FIG. 35 is a block diagram showing an example of the inner structure of a video processing unit 3402.

FIG. 36 shows a positional relationship among cameras and a subject.

FIG. 37 shows a relationship between parallax and an actual distance.

FIG. 38 is a flow chart showing depth information conversion performed by the video processing device 3400.

FIG. 39 is an illustration for explaining plane shifting.

FIG. 40 is a flow chart showing actual distance calculation according to Embodiment 5.

FIG. 41 shows an example in which the video processing device according to the present invention is embodied using LSI.

### DESCRIPTION OF EMBODIMENTS

The following describes embodiments of the present invention with reference to the drawings.

### Embodiment 1

<1.1 Overview>

A video processing device according to Embodiment 1 calculates parallax for a region on a stereoscopic video image in which an object is to be overlaid, determines an amount of parallax for the object based on the calculated parallax, and performs overlaying of the object. Parallax refers to an offset amount (a shift amount) in a horizontal direction between corresponding pixels in a set of a left-view video image and a right-view video image.

The video processing device first extracts a feature point suitable for calculation of parallax from pixels constituting an object-overlaying region on a stereoscopic video image in which an object, such as graphics, a symbol, and a letter, is to be overlaid and a region near the object-overlaying region. The video processing device then calculates parallax for the extracted feature point, and calculates, based on the calculated parallax for the feature point, parallax for each pixel constituting the object-overlaying region on the stereoscopic video image. The video processing device determines parallax for the object considering the parallax for the object-overlaying region, and performs overlaying. With this structure, parallax for the object-overlaying region is calculated with speed and accuracy, and an object having an appropriate stereoscopic effect is overlaid on a stereoscopic video image with speed in real time. The following describes Embodiment 1 with reference to the drawings.

<1.2 Structure of Video Processing Device 100>

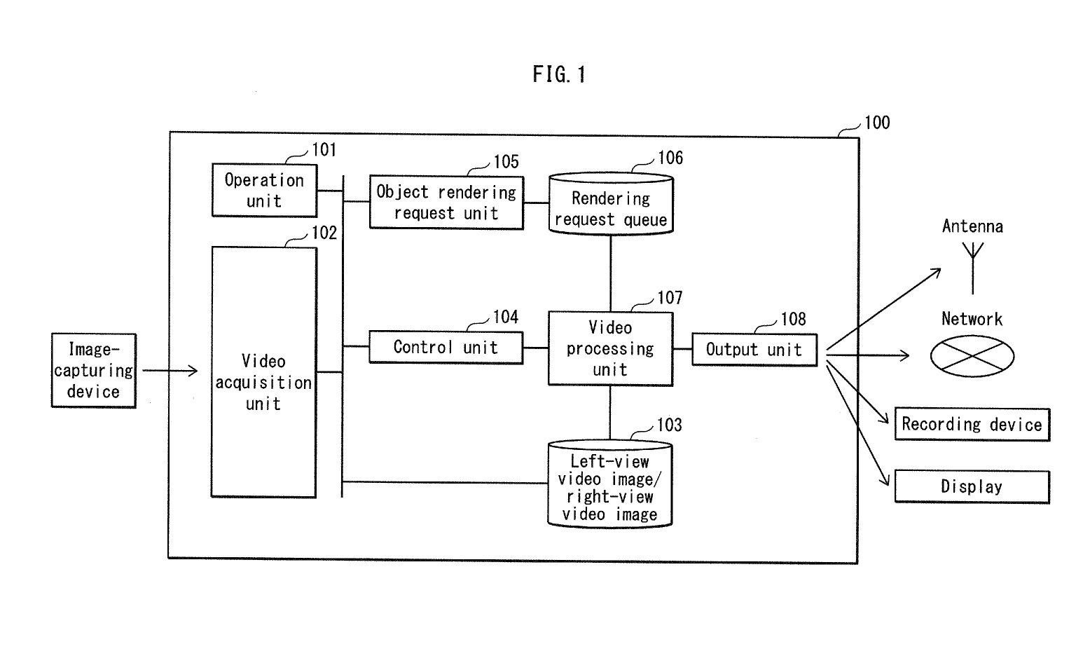

The structure of a video processing device 100 according to Embodiment 1 is described first. FIG. 1 is a block diagram showing an example of the structure of the video processing device 100. As shown in FIG. 1, the video processing device 100 includes an operation unit 101, a video acquisition unit 102, a left-view video image/right-view video image storage unit 103, a control unit 104, an object rendering request unit 105, a rendering request queue storage unit 106, a video processing unit 107, and an output unit 108. The following describes each of these units.

<1.2.1 Operation Unit 101>

The operation unit 101 is used to perform input to the video processing device 100, and includes a touch panel, a keyboard, a mouse, and other controllers, for example. A user designates contents, a position, and the like of object data, such as graphics, a symbol, and a letter, to be overlaid on a stereoscopic video image.

<1.2.2 Video Acquisition Unit 102>

The video acquisition unit 102 acquires a stereoscopic video image composed of a left-view video image (main-view data) and a right-view video image (sub-view data). As shown in FIG. 1, the stereoscopic video image acquired by the video acquisition unit 102 is a stereoscopic video image shot in real time with an image-capturing device connected to the video processing device 100.

<1.2.3 Left-view Video Image/Right-View Video Image Storage Unit 103>

The left-view video image/right-view video image storage unit 103 stores therein the stereoscopic video image acquired by the video acquisition unit 102 as uncompressed picture data (a left-view video image and a right-view video image). The picture data stored in the left-view video image/right-view video image storage unit 103 is the target of overlaying of an object.

<1.2.4 Control Unit 104>

The control unit 104 controls an operation of the video processing device 100. In particular, the control unit 104 controls a timing for overlaying based on timing information stored therein.

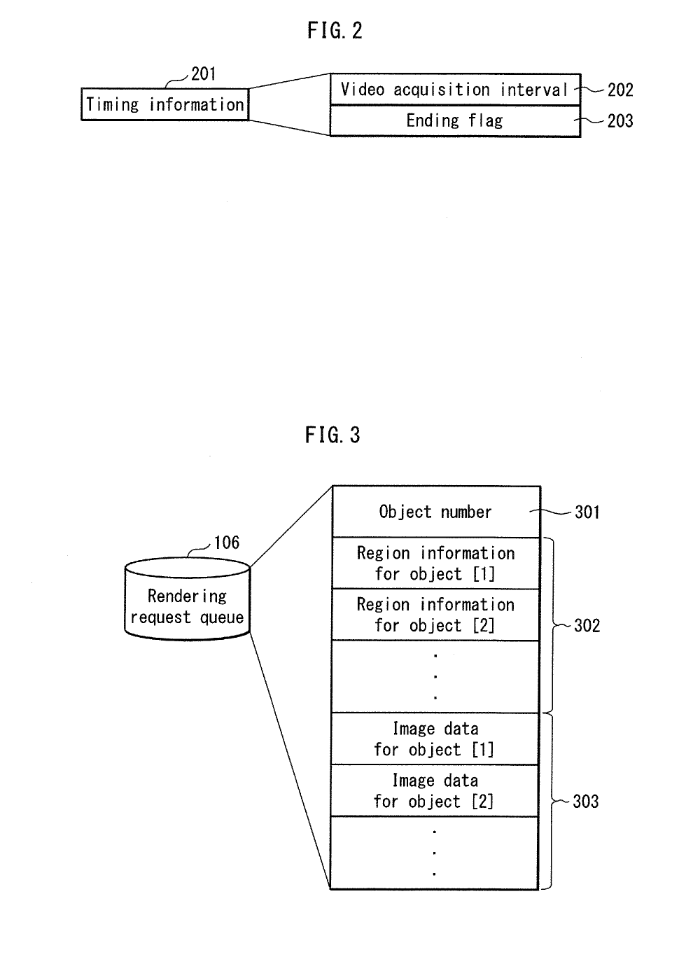

FIG. 2 is a schematic diagram showing the data structure of timing information 201. As shown in FIG. 2, the timing information 201 includes a video acquisition interval 202 and an ending flag 203.

The video acquisition interval 202 indicates intervals at which a drive event is issued to the object rendering request unit 105. The video processing device 100 performs overlaying at the indicated intervals. For example, when a value of the video acquisition interval 202 is 3000 and a counter cycle of the control unit is 90 KHz, the control unit 105 issues a drive event to the object rendering request unit 105 at intervals of 1/30 seconds.

The ending flag 203 indicates whether or not an operation of the video processing device 100 is completed. A default value of the ending flag 203 when the video processing device 100 is started is FALSE. When the operation unit 101 or the like performs an operation to complete the operation of the video processing device 100, the control unit 104 rewrites the ending flag 203 so that a value thereof becomes TRUE, and stops issuing a drive event.

<1.2.5 Object Rendering Request Unit 105 and Rendering Request Queue Storage Unit 106>

The object rendering request unit 105 generates a rendering request queue 106 indicating information relating to an object, such as graphics, a symbol, and a letter, to be overlaid on a stereoscopic video image, based on contents, a position, and the like of object data designated through the operation unit 101. The rendering request queue 106 is generated each time a drive event is issued by the control unit 104.

FIG. 3 is a schematic diagram showing the data structure of the rendering request queue 106. As shown in FIG. 3, the rendering request queue 106 includes an object number 301, region information 302, and image data 303.

The object number 301 indicates the number of objects to be overlaid.

The region information 302 indicates, for each object, an object-overlaying region on a left-view video image constituting main-view data in which the object is to be overlaid, and stores therein coordinates of each of vertices of the object, for example. Rectangle coordinates of a square object, or center coordinates and a radius of a circular object may be stored instead. Furthermore, a bit map showing the object-overlaying region may be stored. Although a data example of the region information 302 is described above, the data structure of the region information 302 is not limited to that described above as long as the region information 302 has the data structure showing the object-overlaying region.

The image data 303 indicates image data for each object. The image data 303 is overlaid on each of a left-view video image and a right-view video image.

<1.2.6 Video Processing Unit 107>

The video processing unit 107 overlays an object on each of the left-view video image and the right-view video image stored in the left-view video image/right-view video image storage unit 103, based on the rendering request queue 106. At the time of overlaying the object, the video processing unit 107 extracts a feature point suitable for calculation of parallax from pixels constituting the object-overlaying region on a stereoscopic video image and a region near the object-overlaying region. The video processing unit 107 then calculates parallax for the extracted feature point by performing a search for corresponding points, and calculates, based on the calculated parallax for the feature point, parallax for each pixel constituting the object-overlaying region on the stereoscopic video image. The video processing unit 107 determines parallax for the object considering the calculated parallax for the object-overlaying region, and performs overlaying. The inner structure of the video processing unit 108 is described in detail in the section <1.3>.

<1.2.7 Output Unit 109>

The output unit 109 outputs the stereoscopic video image on which overlaying has been performed by the video processing unit 108. As shown in FIG. 1, the output unit 109 outputs the stereoscopic video image on which overlaying has been performed to a display, for example. The stereoscopic video image on which overlaying has been performed may be transmitted over the network. The stereoscopic video image on which overlaying has been performed may be transmitted via an antenna. The stereoscopic video image on which overlaying has been performed may be written into a recording device. The recording device includes an optical disc such as a hard disk drive, BD, and DVD, and a semiconductor memory device such as an SD memory card, for example.

This concludes the description of the structure of the video processing device 100. The video processing unit 107 included in the video processing device 100 is described next.

<1.3 Structure of Video Processing Unit 107>

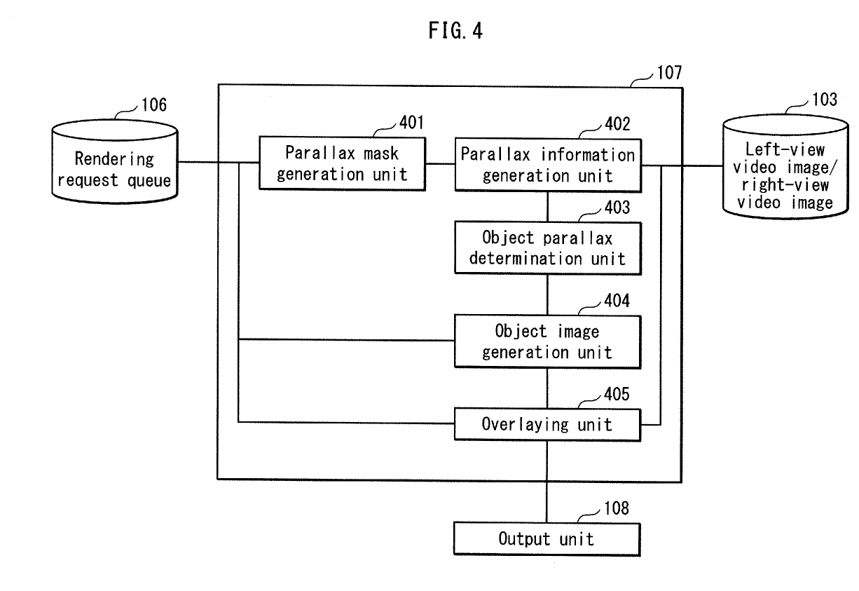

FIG. 4 is a block diagram showing an example of the inner structure of the video processing unit 107. As shown in FIG. 4, the video processing unit 107 includes a parallax mask generation unit 401, a parallax information generation unit 402, an object parallax determination unit 403, an object image generation unit 404, and an overlaying unit 405. The following describes each of these units.

<1.3.1 Parallax Mask Generation Unit 401>

The parallax mask generation unit 401 generates a parallax mask indicating a region on a left-view video image targeted for calculation of parallax, based on the region information 302 included in the rendering request queue 106 generated by the object rendering request unit 105. The parallax mask is a binary bit map. Each pixel in the object-overlaying region takes a value of 1, whereas each pixel in the other region takes a value of 0.

<1.3.2 Parallax Information Generation Unit 402>

The parallax information generation unit 402 calculates parallax for each pixel constituting the region indicated by the parallax mask generated by the parallax mask generation unit 401. Specifically, the parallax information generation unit 402 first extracts a feature point suitable for calculation of parallax from pixels constituting the object-overlaying region on a stereoscopic video image and a region near the object-overlaying region. The parallax information generation unit 402 then calculates parallax for the extracted feature point by performing a search for corresponding points. The parallax information generation unit 402 calculates pixels in the object-overlaying region other than the feature point by deriving a formula indicating parallax distribution in the object-overlaying region based on the calculated parallax for the feature point. The inner structure of the parallax information generation unit 402 is described in detail in the section <1.4>.

<1.3.3 Object Parallax Determination Unit 403>

The object parallax determination unit 403 determines an amount of parallax provided to the object to be overlaid on the stereoscopic video image. Specifically, the object parallax determination unit 403 specifies the object-overlaying region on a left-view video image based on the rendering request queue 106, and detects a maximum amount of parallaxes for respective pixels constituting the object-overlaying region based on the parallax information generated by the parallax information generation unit 402. The object parallax determination unit 403 determines the detected maximum amount of parallaxes as the amount of parallax for the object. The object parallax determination unit 403 stores the amount of parallax determined for each object as object parallax information.

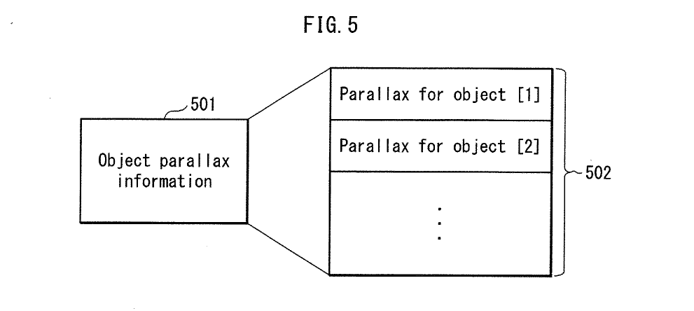

FIG. 5 is a schematic diagram showing the data structure of object parallax information 501. As shown in FIG. 5, the object parallax information 501 stores therein parallax 502 for each object stored in the rendering request queue 106.

<1.3.4 Object Image Generation Unit 404>

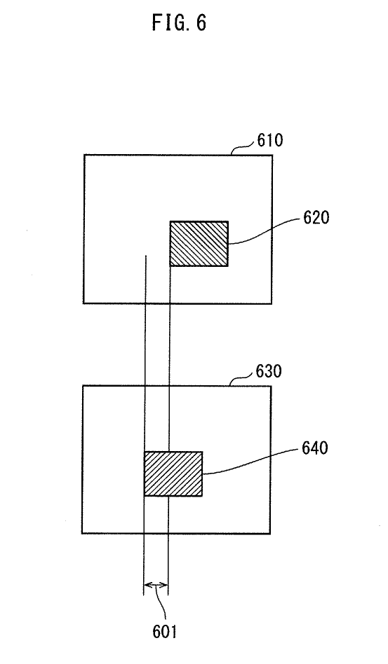

The object image generation unit 404 generates a left-view object image to be overlaid on the left-view video image and a right-view object image to be overlaid on the right-view video image. FIG. 6 is an illustration for explaining generation of the object images. As shown in FIG. 6, the object image generation unit 404 generates a left-view object image 610 based on the region information 302 stored in the rendering request queue 106. The object image generation unit 404 then generates a right-view object image 630 by shifting an object 620 to the left by an amount of parallax 601, based on the object parallax information 501 determined by the object parallax determination unit 403.

<1.3.5 Overlaying Unit 405>

The overlaying unit 405 performs overlaying of the object on each of the left-view video image and the right-view video image, and combines the left-view video image with the right-view video image by a side-by-side method.

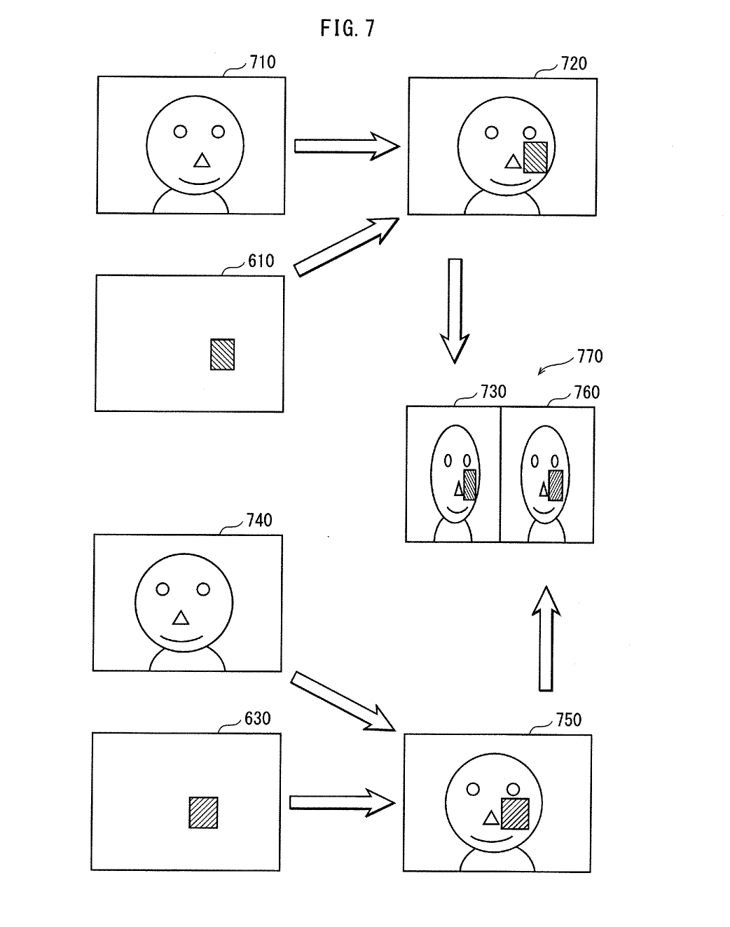

FIG. 7 is an illustration for explaining overlaying performed by the overlaying unit 405. As shown in FIG. 7, the overlaying unit 405 overlays the left-view object image 610 on the left-view video image 710 to generate a left-view overlaid image 720. The overlaying unit 405 also overlays the right-view object image 630 on the right-view video image 740 to generate a right-view overlaid image 750. The overlaying unit 405 reduces sizes of the left-view overlaid image 720 and the right-view overlaid image 750, and places the reduced left-view overlaid image 730 and the reduced right-view overlaid image 760 in the left half and the right half of a whole image, respectively.

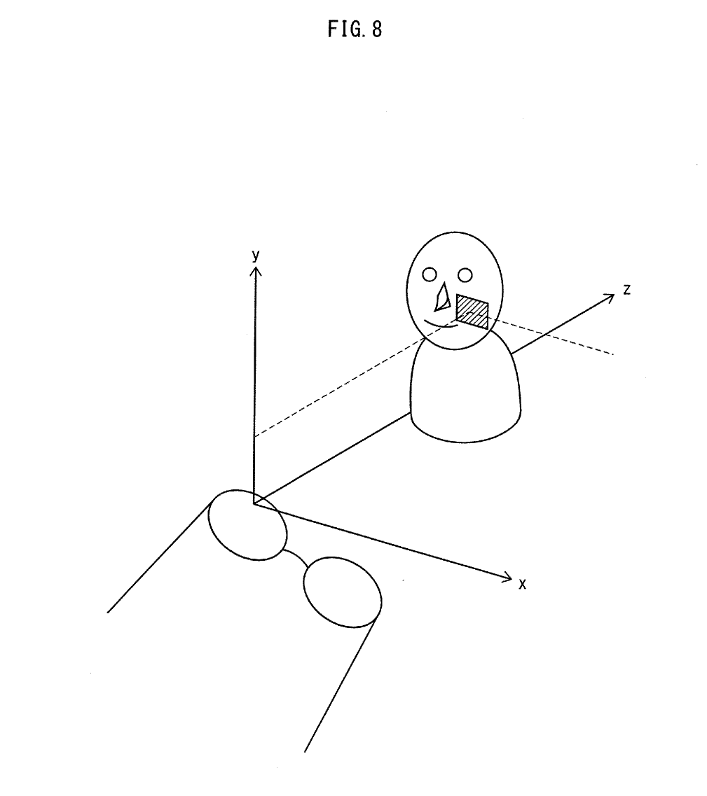

FIG. 8 shows stereoscopic viewing of a stereoscopic video image after overlaying. As shown in FIG. 8, when the stereoscopic video image generated by the overlaying unit 405 is observed using 3D glasses, a hatched object appears to be in front of a face portion located in the object-overlaying region.

Although a case where the side-by-side method is used to combine the left-view overlaid image with the right-view overlaid image is described above, the other methods may be adopted. The other methods include an interlace method in which the left-view overlaid image and the right-view overlaid image are respectively placed in even lines and odd lines and a frame sequential method in which the left-view overlaid image and the right-view overlaid image are respectively allocated to odd frames and even frames.

This concludes the description of the structure of the video processing unit 107. The parallax information generation unit 402 included in the video processing unit 107 is described next.

<1.4 Structure of Parallax Information Generation Unit 402>

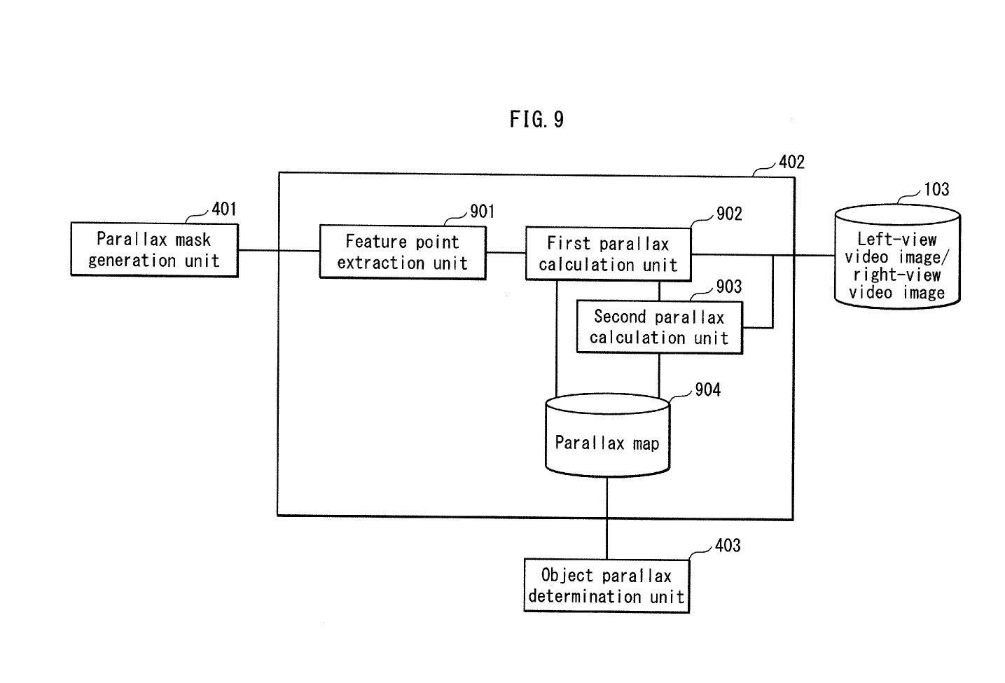

FIG. 9 is a block diagram showing the inner structure of the parallax information generation unit 402. As shown in FIG. 9, the parallax information generation unit 402 includes a feature point extraction unit 901, a first parallax calculation unit 902, a second parallax calculation unit 903, and a parallax map storage unit 904. The following describes each of these units.

<1.4.1 Feature Point Extraction Unit 901>

The feature point extraction unit 901 extracts a feature point from the region indicated by the parallax map and a region near the indicated region. Information including coordinates of the extracted feature point and the like is stored as search information. Details of the extraction of a feature point are described in the following sections <Extraction of Feature Point>, <Search Information>, and <Region from Which Feature Point is Extracted>.

<1.4.1.1 Extraction of Feature Point>

The feature point refers to a pixel suitable for a search for corresponding points performed to calculate parallax. The feature point extraction unit 901 extracts an edge (a portion in which a sharp change in brightness is exhibited) or an intersection of edges as the feature point. The edge is detected by calculating a difference in brightness between pixels (first derivation), and calculating edge intensity from the calculated difference. The feature point may be extracted by other edge detection methods. A region from which a feature point is extracted is described later. This concludes the description of the extraction of a feature point. The search information is described next.

<1.4.1.2 Search Information>

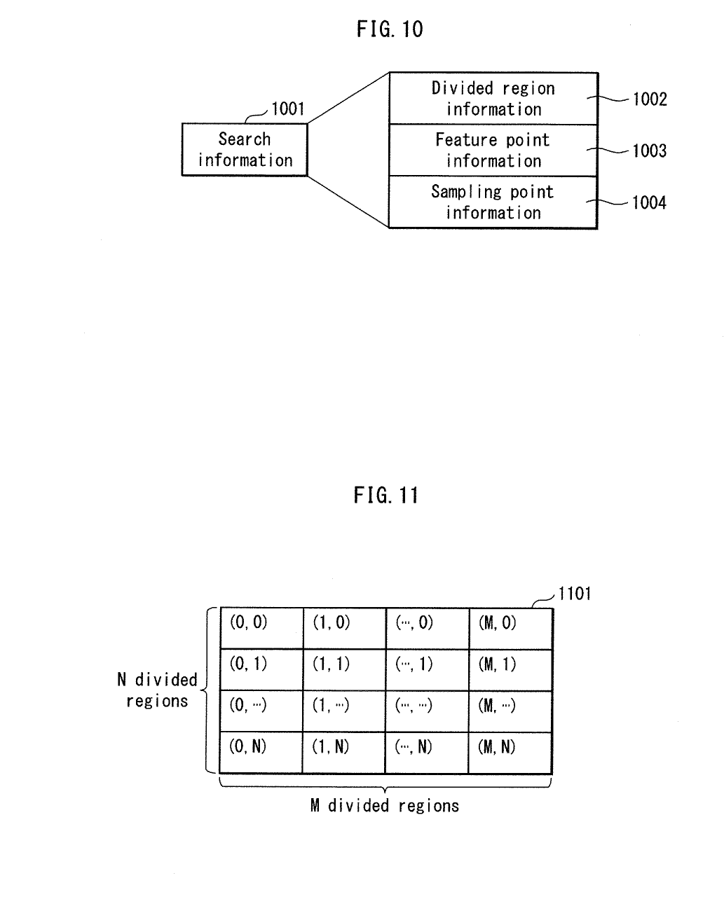

The search information shows coordinates of the extracted feature point, parallax for the extracted feature point, and the like. FIG. 10 is a schematic diagram showing the data structure of search information 1001. As shown in FIG. 10, the search information 1001 includes divided region information 1002, feature point information 1003, and sampling point information 1004. The divided region information 1002 is information relating to a feature point included in each of divided regions obtained by dividing a left-view video image. The feature point information 1003 shows coordinates of a feature point, parallax for the feature point, and the like. The sampling point information 1004 relates to a feature point used in calculation of parallax performed by the second parallax calculation unit 903 (sampling point). The feature point extraction unit 901 updates the search information 1001 each time a feature point is extracted and parallax for the extracted feature point is calculated.

The divided region information 1002 is described first. The divided region information 1002 is information relating to a feature point for each divided region. Although described in detail in the section <1.4.1.3>, the feature point extraction unit 901 divides a left-view video image into M×N divided regions as shown in FIG. 11, and stores, for each divided region, information relating to a feature point in order to perform a search for a feature point in units of divided regions.

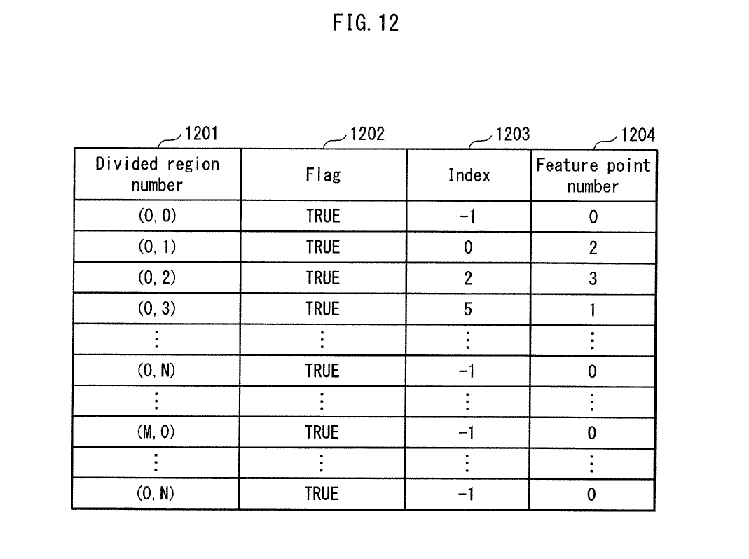

FIG. 12 shows a data example of the divided region information 1002. As shown in FIG. 12, the divided region information 1002 includes, for each divided region, a divided region number 1201, a flag 1202 indicating whether or not a search for a feature point has been performed, a start index 1203 of an array in which one or more feature points are stored, and feature point number 1204 indicating the number of feature points included in a corresponding divided region. The divided region number 1201 corresponds to an identifier 1101 for each divided region shown in FIG. 11. The flag 1202 is set to TRUE when a search for a feature point has been performed in a corresponding divided region, and to FALSE when the search has not been performed in the corresponding divided region. When a corresponding divided region includes one or more feature points for which parallax has been calculated by the feature point extraction unit 901, the index 1203 stores therein a start index (>0) of an array of feature point information pieces corresponding to the feature point information 1003 described later. On the other hand, when a corresponding divided region does not include any feature point for which parallax has been calculated, the index 1203 is set to “−1”. The feature point number 1204 indicates the number of feature points included in a corresponding divided region. This concludes the description of the divided region information 1002. The feature point information 1003 is described next.

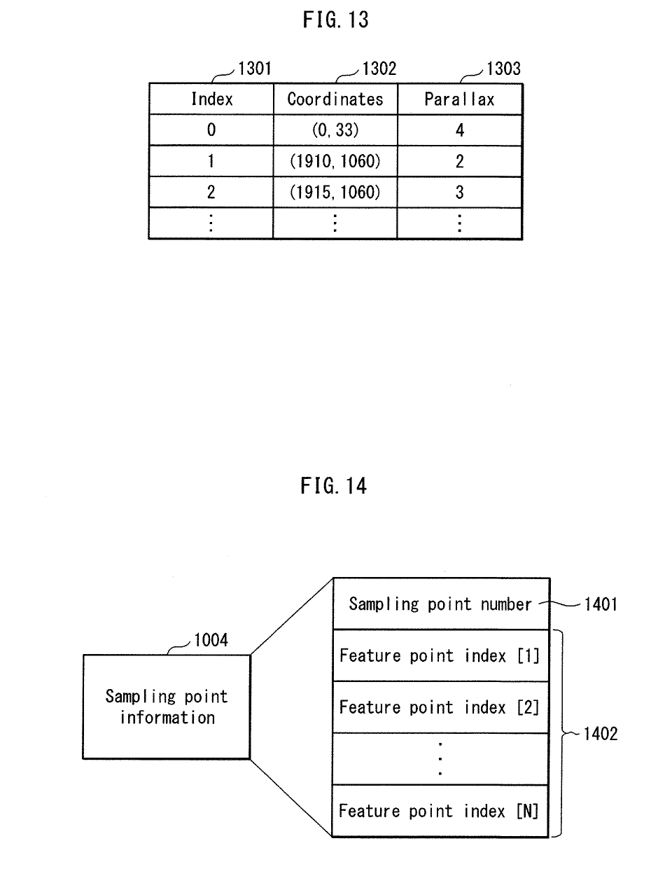

FIG. 13 shows a data example of the feature point information 1003. As shown in FIG. 13, the feature point information 1003 includes an index 1301 of a feature point, coordinates 1302 of the feature point, and parallax 1303 for the feature point. The index 1301 corresponds to the index 1203 shown in FIG. 12. The coordinates 1302 indicate coordinates of a feature point in a left-view video image. The parallax 1303 indicates a value of parallax between a feature point in a left-view video image and a corresponding feature point in a right-view video image.

Since the index included in the divided region information 1002 corresponds to the index included in the feature point information 1003, coordinates of a feature point included in a divided region and parallax for the feature point are specified with reference to a value of the index. For example, since the index and the feature point number corresponding to a divided region (0, 1) are respectively set to “0” and “2” in FIG. 12, it is found that feature points included in the divided region (0, 1) are feature points indicated by the indices “0” and “1”. By referring to the values of the indices in the feature point information 1003 shown in FIG. 13, it is found that coordinates of feature points included in the divided region (0, 1) are (0, 33) and (1910, 1060), and parallax for the feature points are “4” and “2”. This concludes the description of the feature point information 1003. The sampling point information 1004 is described next.

The sampling point information 1004 specifies, from among feature points included in the feature point information 1003, one or more feature points used by the second parallax calculation unit 903 to determine a formula for estimating parallax (sampling points). FIG. 14 shows the data structure of the sampling point information 1004. As shown in FIG. 14, the sampling point information 1004 includes a sampling point number 1401 and a feature point index 1402 corresponding to each sampling point. The sampling point number 1401 indicates the number of sampling points. The feature point index 1402 indicates an index number for a feature point corresponding to each sampling point. The index number for a feature point corresponds to the index included in each of the divided region information 1002 and the feature point information 1003. Coordinates of each sampling point and parallax for the sampling point are specified with reference to the feature point information 1003. This concludes the description of the sampling point information 1004. Use of the search information 1001 is described next.

When a search for a feature point is performed, the feature point extraction unit 901 first determines whether or not a search for a feature point has been performed in a divided region targeted for the search, with reference to the divided region information 1002. When the search has already been performed, the feature point extraction unit 901 acquires information indicating coordinates of a feature point and parallax for the feature point, with reference to the feature point information 1003 specified by the index 1203 included in the divided region information 1002. When the search has not been performed, the feature point extraction unit 901 performs edge detection in the divided region targeted for the search to specify a feature point. The feature point extraction unit 901 then calculates parallax for the extracted feature point. As described above, by storing, as the search information 1001, the information indicating coordinates of a feature point having been searched before and parallax for the feature point, and using the stored information when extraction of a feature point is performed, a search for the feature point having been detected before can be omitted.

This concludes the description of the search information 1001. A region from which a feature point is extracted is described next.

<1.4.1.3 Region from which Feature Point is Extracted>

The feature point extraction unit 901 extracts a feature point suitable for calculation of parallax from pixels constituting the region (object-overlaying region) on the left-view video image indicated by the parallax mask and a region on the left-view video image located near the object-overlaying region. Specifically, the left-view video image are divided into four regions referred to as divided quadrants by using axes that intersect at right angles at a target pixel (a pixel for which parallax has not been calculated) in the object-overlaying region, and extraction of a feature point is performed for each divided quadrant. In the extraction of a feature point performed for each divided quadrant, extraction of a feature point is performed first in a divided region including the target pixel. The divided region here means each of the M×N divided regions shown in FIG. 11, which has been obtained by dividing the left-view video image. When a predetermined number of feature points are extracted from one divided region included in a divided quadrant, extraction of a feature point is no longer performed in the other divided regions included in the divided quadrant. When the predetermined number of feature points are not extracted from the one divided region included in the divided quadrant, a search range is expanded into another divided region adjacent to the one divided region included in the divided quadrant. The search range is expanded until the predetermined number of feature points are extracted or the search is performed for all the divided regions included in the divided quadrant. The region from which a feature point is extracted is described in more detail below, with use of the drawings.

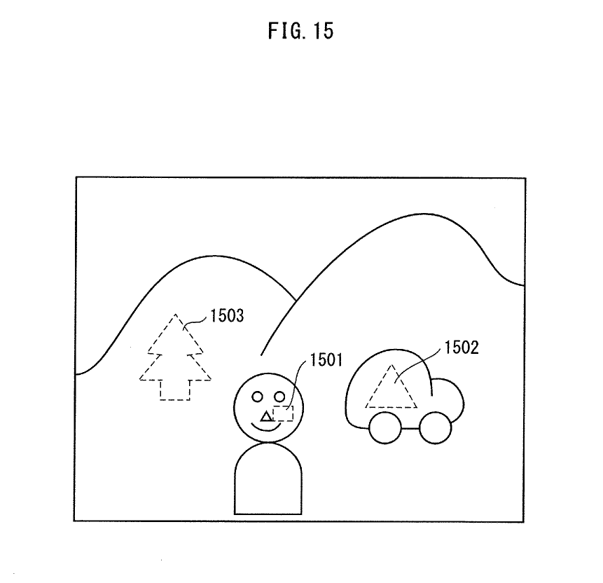

FIG. 15 shows examples of the region on the left-view video image indicated by the parallax mask. In the examples shown in FIG. 15, regions 1501, 1502, and 1503 enclosed by dotted lines are the object-overlaying regions. The feature point extraction unit 901 extracts a feature point suitable for calculation of parallax from pixels constituting the object-overlaying region and a region on the left-view video image located near the object-overlaying region. The following describes extraction of a feature point for the region 1501, with use of the drawings.

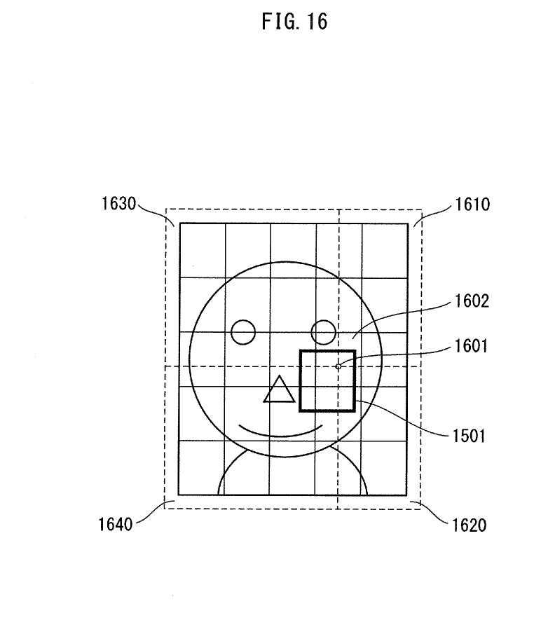

FIG. 16 is an illustration for explaining extraction of a feature point for the region 1501. In FIG. 16, 1601 represents a pixel for which parallax has not been calculated, 1602 represents a divided region including the pixel 1601, and 1610, 1620, 1630, and 1640 represent respective divided quadrants obtained by dividing the left-view video image by using axes that intersect at right angles at the pixel 1601. The feature point extraction unit 901 performs, for each of the divided quadrants 1610, 1620, 1630, and 1640, extraction of a feature point while expanding a search range until a predetermined number of feature points are extracted or the search is performed for all the divided regions included in the divided quadrant.

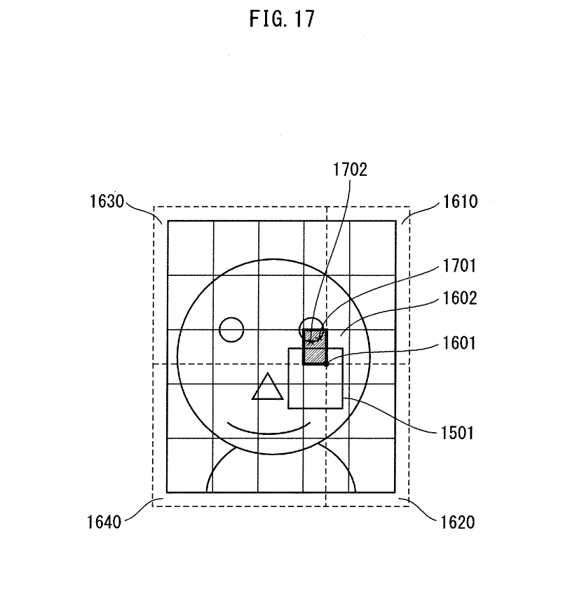

FIG. 17 is an illustration showing extraction of a feature point for the divided quadrant 1630. As shown in FIG. 17, the feature point extraction unit 901 performs extraction of a feature point first for a region in which the divided region 1602 and the divided quadrant 1630 overlap each other (hatched region in FIG. 17). In the search for a feature point for the region, the feature point extraction unit 901 extracts feature points 1701 and 1702. In this case, since a predetermined number (two in this example) of feature points are extracted, the search range is not expanded and extraction of a feature point for the divided quadrant 1630 is completed. The following describes extraction of a feature point for the divided quadrant 1640.

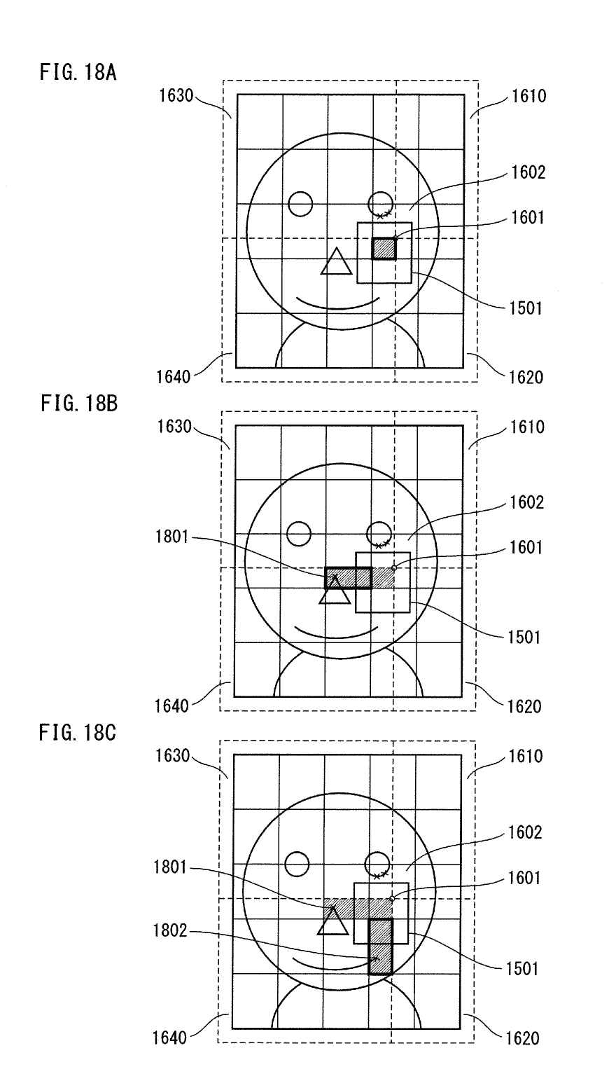

FIGS. 18A to 18C are illustrations each showing extraction of a feature point for the divided quadrant 1640. As shown in FIG. 18A, the feature point extraction unit 901 performs extraction of a feature point first for a region in which the divided region 1602 and the divided quadrant 1640 overlap each other (hatched region in FIG. 18A). Since no feature point is extracted in the search for a feature point for the region, the feature point extraction unit 901 expands the search range. The search range is expanded into a region adjacent to the searched region.

FIG. 18B is an illustration showing extraction of a feature point for the region into which the search range is expanded. The hatched region in FIG. 18B indicates a target region into which the search range is expanded. In the search for a feature point for the region, the feature point extraction unit 901 extracts a feature point 1801. In this case, since a predetermined number of feature points are not extracted, the feature point extraction unit 901 further expands the search range into another region.

FIG. 18C is an illustration showing extraction of a feature point for the region into which the search range is further expanded. The hatched region in FIG. 18C indicates a target region into which the search range is further expanded. In the search for a feature point for the region, the feature point extraction unit 901 extracts a feature point 1802. In this case, since the predetermined number of feature points, i.e. the feature points 1801 and 1802, are extracted, the feature point extraction unit 901 does not expand the search range and completes extraction of a feature point for the divided quadrant 1640. Similarly, for each of the divided quadrants 1610 and 1620, the feature point extraction unit 901 performs extraction of a feature point while expanding the search range until a predetermined number of feature points are extracted or the search is performed for all the divided regions included in the divided quadrant.

As described above, by extracting a feature point not only from pixels constituting the object-overlaying region but also from pixels constituting a region near the object-overlaying region and expanding a search range when a predetermined number of feature points are not extracted, it is possible to extract one or more feature points required to calculate parallax for the object-overlaying region and to calculate a value of parallax with accuracy. In addition, by dividing the left-view video image into four divided quadrants and performing extraction of a feature point for each divided quadrant, it is possible to extract feature points with no bias. The expression “with no bias” in the aforementioned sentence means that the extracted feature points do not concentrate in one region. Since the feature points are extracted with no bias, a formula indicating parallax distribution in the object-overlaying region described later is appropriately derived. This concludes the description of the feature point extraction unit 901. The first parallax calculation unit 902 is described next.

<1.4.2 First Parallax Calculation Unit 902>

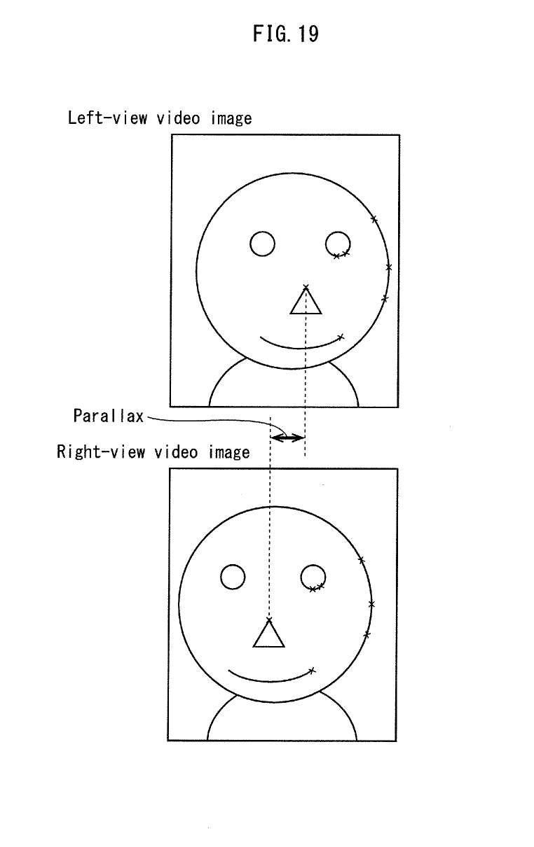

The first parallax calculation unit 902 calculates parallax for each feature point extracted by the feature point extraction unit 901. The calculated parallax is stored as the feature point information 1003. FIG. 19 is an illustration showing calculation of parallax for a feature point. As shown in FIG. 19, the first parallax calculation unit 902 detects, from the right-view video image, a pixel corresponding to a feature point extracted from the left-view video image (corresponding point), and determines a distance (the number of pixels) between the corresponding pixels as parallax for the feature point. The search for corresponding points is performed by calculating a correlation value for each pixel based on a brightness value and the like, and detecting a pixel with the highest correlation value. Although there may be a case where an erroneous corresponding point is detected from a region in which there is little change in brightness, it is possible to detect corresponding points with accuracy in this example because an edge at which a sharp change in brightness is exhibited is extracted as a feature point. This concludes the description of the first parallax calculation unit 902. The second parallax calculation unit 903 is described next.

<1.4.3 Second Parallax Calculation Unit 903>

The second parallax calculation unit 903 calculates pixels in the object-overlaying region other than the feature point by deriving a formula indicating parallax distribution in the object-overlaying region, based on the parallax for the feature point calculated by the first parallax calculation unit 902. Details of the calculation of the pixels are described in the following sections <Parallax Calculation Method> and <Region in Which Calculation of Parallax is Performed>.

<1.4.3.1 Parallax Calculation Method>

The second parallax calculation unit 903 determines the formula indicating parallax distribution in the object-overlaying region (parallax calculation formula) from coordinates of each of sampling points 1 to N and parallax for each sampling point that are obtained with reference to the sampling point information 1004, and calculates parallax by applying the determined formula to each pixel.

An example of a parallax estimation model is shown below.

D(x,y)=p₁x²+p₂xy+p₃y²+p₄x+p₅y+p₆ [Formula 1]

The second parallax calculation unit 903 determines a parameter p of the parallax estimation model shown above from coordinates (x[i], y[i]) of a sampling point i (i=1 to N) and an amount of parallax D [i] for the sampling point i by a least squares method. That is to say, the second parallax calculation unit 903 calculates the parameter p that minimizes the sum of the squares of D [i]−D (x[i], y[i]). The parallax calculation formula indicating parallax distribution in the object-overlaying region is determined in the above-mentioned manner. The second parallax calculation unit 903 then substitutes, into the parallax calculation formula, coordinates of each of the pixels, other than the feature point, constituting a region to which the parallax calculation formula is applied. The region to which the parallax calculation formula is applied is described later. Parallax for each of the pixels, other than a feature point, constituting the region to which the parallax calculation formula is applied is obtained in the above-mentioned manner. By repeatedly performing extraction of a feature point, determination of a parallax calculation formula, and application of the parallax calculation formula described above, parallax for the region indicated by the parallax mask is calculated. This concludes the description of the parallax calculation method. A region in which calculation of parallax is performed is described next.

<1.4.3.2 Region in which Calculation of Parallax is Performed>

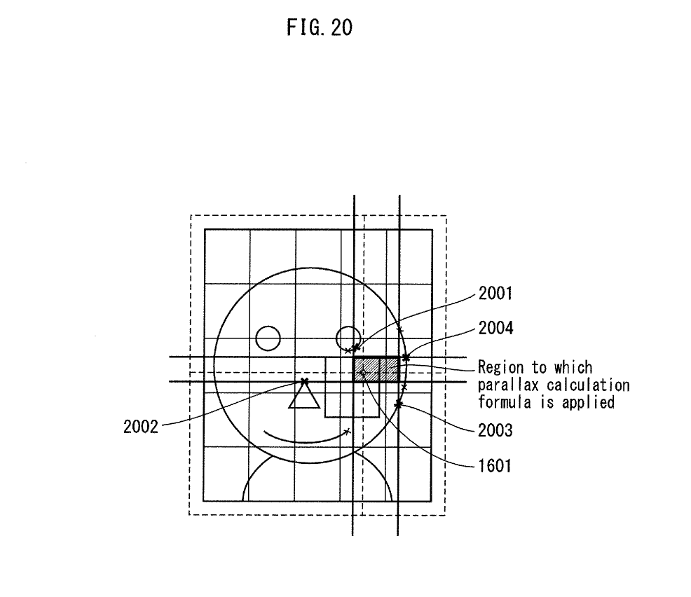

FIG. 20 shows the region in which calculation of parallax is performed. FIG. 20 corresponds to FIGS. 16, 17, and 18 for explaining the region from which a feature point is extracted. In FIG. 20, a hatched region is the region to which the parallax calculation formula is applied. The region to which the parallax calculation formula is applied is determined in the following manner.

That is to say, the left side of the region to which the parallax calculation formula is applied is determined so that an x coordinate of the left side corresponds to an x coordinate of a rightmost sampling point of all the sampling points positioned to the left of the pixel 1601 for which parallax has not been calculated. The right side of the region to which the parallax calculation formula is applied is determined so that an x coordinate of the right side corresponds to an x coordinate of a leftmost sampling point of all the sampling points positioned to the right of the pixel 1601 for which parallax has not been calculated. The upper side of the region to which the parallax calculation formula is applied is determined so that a y coordinate of the upper side corresponds to a y coordinate of a lowermost sampling point of all the sampling points positioned above the pixel 1601 for which parallax has not been calculated. The lower side of the region to which the parallax calculation formula is applied is determined so that a y coordinate of the lower side corresponds to a y coordinate of an uppermost sampling point of all the sampling points positioned below the pixel 1601 for which parallax has not been calculated. The second parallax calculation unit 903 applies the parallax calculation formula to all the pixels constituting the region to which the parallax calculation formula is applied determined in the above-mentioned manner to calculate parallax.

<1.4.4 Parallax Map Storage Unit 904>

The parallax map storage unit 904 stores therein a value of parallax for the feature point in the object-overlaying region calculated by the first parallax calculation unit 902 and a value of parallax for each of the pixels in the object-overlaying region other than the feature point calculated by the second parallax calculation unit 903. The parallax map stored in the parallax map storage unit 904 is used by the object parallax determination unit 403 to determine an amount of parallax provided to an object.

This concludes the description of the structure of the video processing device 100. An operation of the video processing device 100 having the above-mentioned structure is described next.

<1.5 Operation>

<1.5.1 Overall Operation>

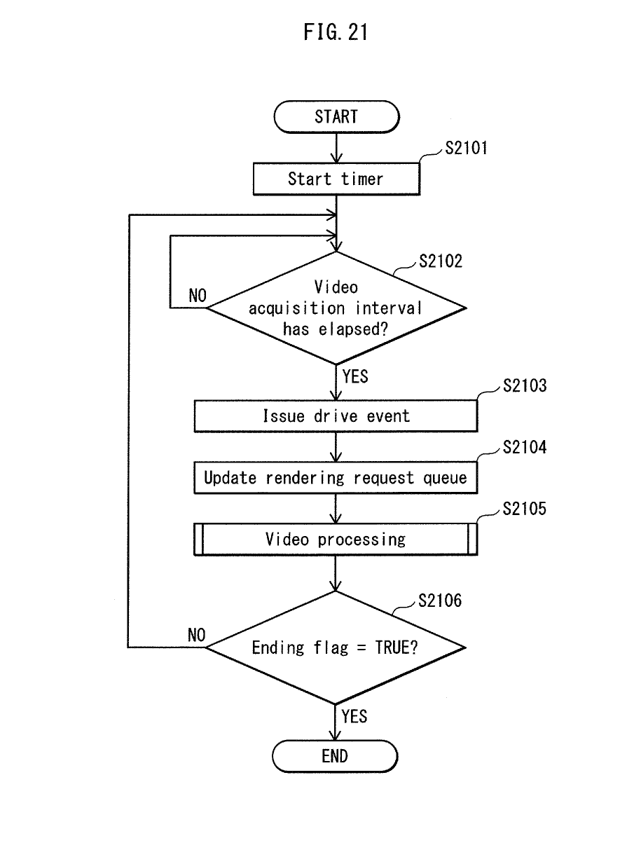

An overall operation of the video processing device 100 is described first. FIG. 21 is a flow chart showing an operation of the video processing device 100.

As shown in FIG. 21, the control unit 104 first starts a timer (step S2101). When a time period indicated by the video acquisition interval 202 included in the timing information 201 has elapsed (step S2102, YES), the control unit 104 issues a drive event to the object rendering request unit 105 (step S2103). Upon receiving the drive event issued by the control unit 104, the object rendering request unit 105 updates the rendering request queue 106 (step S2104). The video processing unit 107 performs video processing including extraction of a feature point, calculation of parallax, and overlaying, based on the rendering request queue 106 (step S2105). Details of the processing performed in the step S2105 are described in the section <1.5.2>.

When a value of the ending flag 203 included in the timing information 201 is TRUE after the processing in the step S2105 (step S2106, YES), the control unit 104 completes the operation of the video processing device 100. When the value of the ending flag is not TRUE (step S2106, NO), processing returns to the step S2102. This concludes the description of the overall operation of the video processing device 100. The video processing performed in the step S2105 is described in detail next.

<1.5.2 Video Processing (Step S2105)>

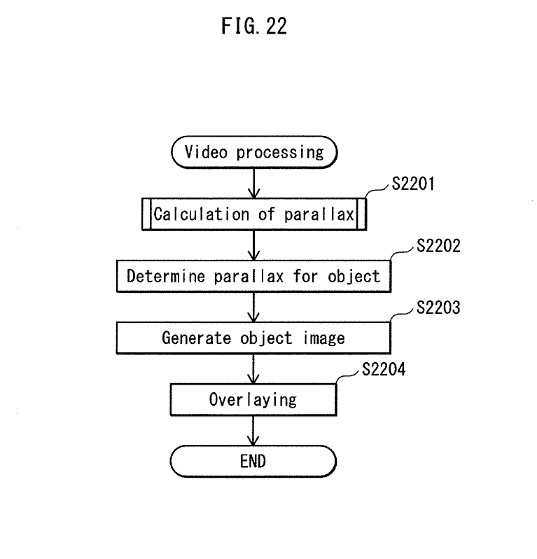

FIG. 22 is a flow chart showing the video processing in the step S2105 in detail. As shown in FIG. 22, the parallax information generation unit 402 first calculates parallax between a left-view video image and a right-view video image for the object-overlaying region (step S2201). The calculation of parallax in the step S2201 is described in detail in the section <1.5.3>.

The object parallax determination unit 403 then determines parallax provided to the object based on the parallax for the object-overlaying region calculated in the step S2201 (step S2202). Specifically, the object parallax determination unit 403 detects a maximum amount of parallaxes for respective pixels constituting the object-overlaying region as the parallax provided to the object. The determined object parallax is stored as the object parallax information 501.

After the processing in the step S2202, the object image generation unit 403 generates an object image based on the object parallax determined in the step S2202 (step S2203). The overlaying unit 405 overlays a left-view object image and a right-view object image on the left-view video image and the right-view video image, respectively (step S2204). This concludes the detailed description of the video processing. Calculation of parallax performed in the step S2201 is described in detail next.

<1.5.3 Calculation of Parallax (Step S2201)>

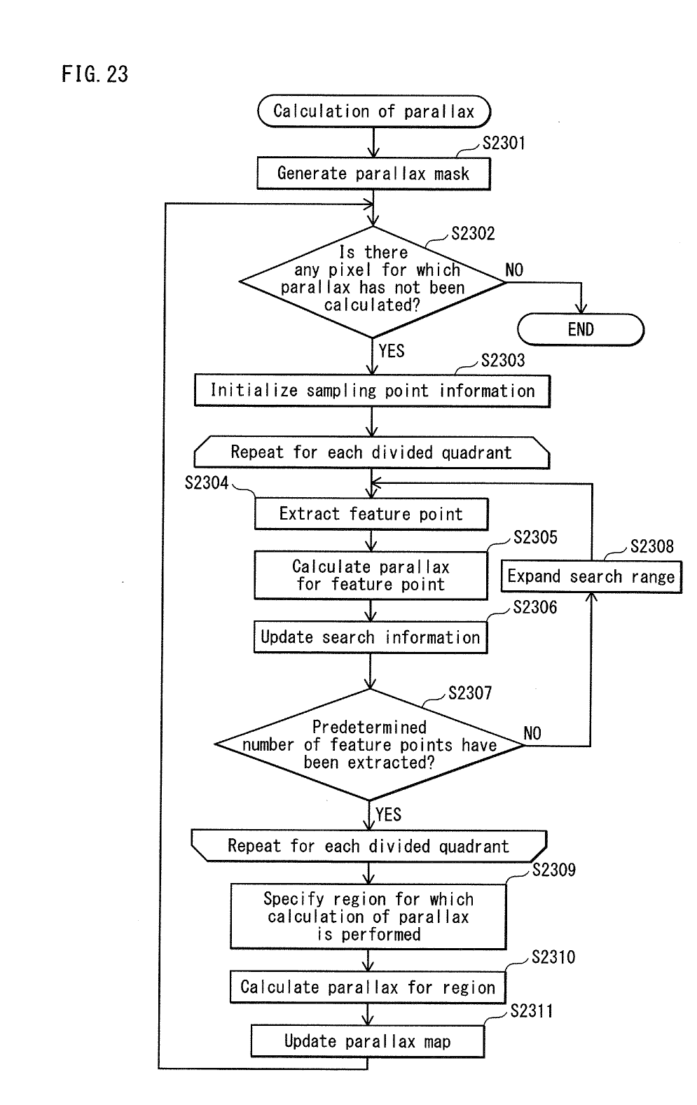

FIG. 23 is a flow chart showing calculation of parallax performed in the step S2201. As shown in FIG. 23, the parallax mask generation unit 401 first generates a parallax mask (step S2301). Specifically, the parallax mask generation unit 401 produces a binary bit map in which each pixel in the object-overlaying region takes a value of 1 and each pixel in the other region takes a value of 0. The parallax information generation unit 402 then performs a search for a pixel for which parallax has not been calculated in the object-overlaying region indicated by the parallax mask (step S2302).

When there is no pixel for which parallax has not been calculated (step S2302, NO), the parallax information generation unit 402 completes calculation of parallax. When the pixel for which parallax has not been calculated is detected (step S2302, YES), the parallax information generation unit 402 initializes the sampling point information 1004 (step S2303). The feature point extraction unit 901 extracts a feature point from the object-overlaying region on the left-view video image and a region near the object-overlaying region (step S2304). A region first targeted for the search is a divided region including the pixel for which parallax has not been calculated detected in the step S2302. When the search range is expanded in the step S2308 described later, a region into which the search range is expanded becomes the region targeted for the search.

After extraction of a feature point, the first parallax calculation unit 902 calculates parallax for the extracted feature point (step S2305). The feature point extraction unit 901 and the first parallax calculation unit 902 update the search information 1001 based on information indicating coordinates of the feature point and parallax for the feature point (step S2306). The feature point extraction unit 901 determines whether or not a predetermined number of feature points have been extracted (step S2307).

When the predetermined number of feature points have not been extracted (step S2307, NO), the feature point extraction unit 901 expands the search range into a divided region adjacent to the searched region (step S2308). The above-mentioned processing in the steps S2304 to S2308 is performed for each divided quadrant.

The second parallax calculation unit 903 specifies a region for which calculation of parallax is performed, based on a sampling point extracted in the steps S2304 to S2308 (step S2309). Specification of the region for which calculation of parallax is performed has already been described in the section <1.4.3.2>. The second parallax calculation unit 903 calculates parallax for the region specified in the step S2309 (step S2310). Specifically, the second parallax calculation unit 903 derives the parallax calculation formula from coordinates of each sampling point and parallax for the sampling point, and calculates parallax for each of pixels, other than the feature point, constituting the specified region using the derived parallax calculation formula.

The second parallax calculation unit 903 updates the parallax map 904 based on the parallax calculated in the step S2310 (step S2311). After the step S2311, processing returns to the step S2302. When there is any other pixel for which parallax has not been calculated (step S2302, YES), processing in and after the step S2303 is performed again. When there is no pixel for which parallax has not been calculated (step S2302, NO), calculation of parallax is completed. This concludes the description of the operation of the video processing device 100.

As describe above, according to the present embodiment, a feature point is extracted from pixels constituting the object-overlaying region and a region near the object-overlaying region, parallax for the object-overlaying region is calculated based on parallax for the extracted feature point, and overlaying of an object is performed based on the calculated parallax for the object-overlaying region. With this structure, an object having an appropriate stereoscopic effect is overlaid on a stereoscopic video image with speed in real time.

### Embodiment 2

<2.1 Overview>

A video processing device according to Embodiment 2 is similar to the video processing device 100 according to Embodiment 1 in that parallax for the object-overlaying region on a stereoscopic video image is calculated, but differs from the video processing device 100 in the method for overlaying an object. The video processing device according to Embodiment 2 overlays an object for which an amount of parallax is predetermined, and compares the amount of parallax predetermined for the object and parallax for the object-overlaying region. The object is not overlaid in a region in which an amount of parallax is larger than the amount of parallax predetermined for the object. With this structure, it is possible to prevent such a condition that a stereoscopic video image appears to project forward from the object and the object appears to be buried within the stereoscopic video image, and a viewer can view the stereoscopic video image and the object overlaid on the stereoscopic video image without a sense of awkwardness.

<2.2 Structure>

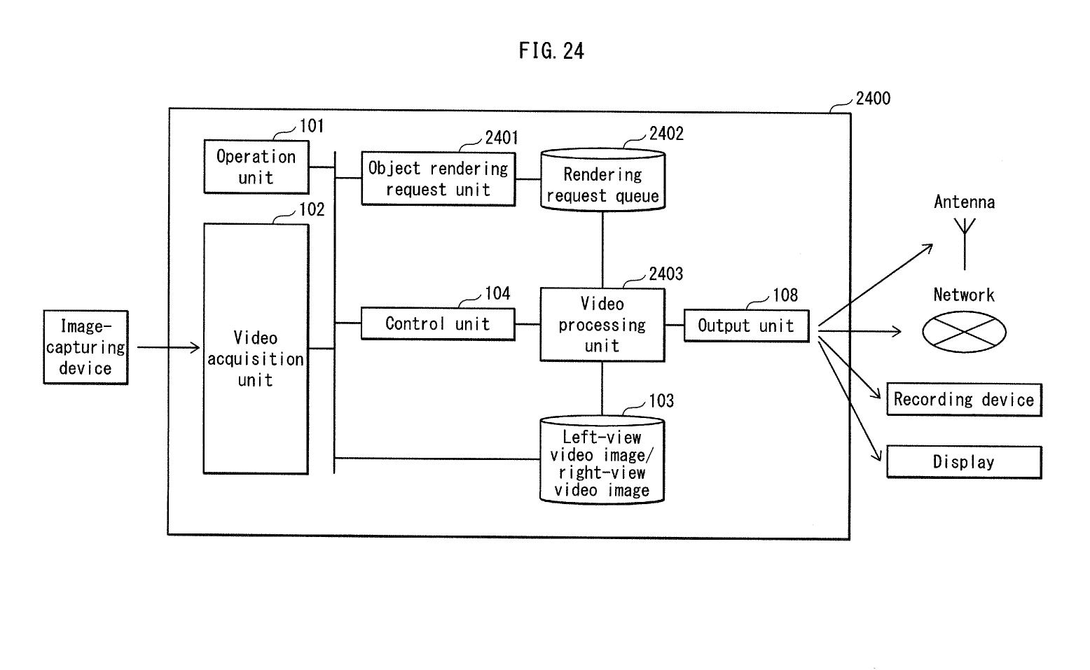

The structure of a video processing device 2400 according to Embodiment 2 is described first. FIG. 24 is a block diagram showing an example of the structure of the video processing device 2400. Components that are the same as the video processing device 100 according to Embodiment 1 are provided with the same reference signs, and a description thereof is omitted. Below, structural differences from the video processing device 100 are described. As shown in FIG. 24, the video processing device 2400 includes the operation unit 101, the video acquisition unit 102, the left-view video image/right-view video image storage unit 103, the control unit 104, an object rendering request unit 2401, a rendering request queue 2402, a video processing unit 2403, and the output unit 108.

<2.2.1 Object Rendering Request Unit 2401 and Rendering Request Queue 2402>

The object rendering request unit 2401 generates a rendering request queue 2402 including information relating to an object to be overlaid, such as graphics, a symbol, and a letter, and an amount of parallax provided to the object, according to a drive event issued by the control unit 104. The object rendering request unit 2401 and the rendering request queue 2402 respectively differ from the object rendering request unit 105 and the rendering request queue 106 according to Embodiment 1 in that the amount of parallax provided to the object is predetermined.

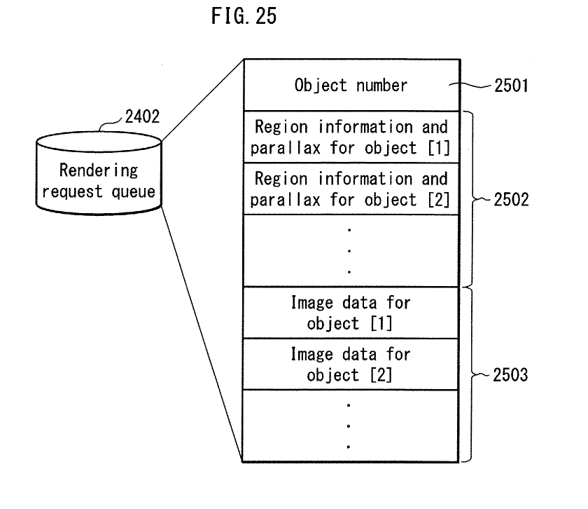

FIG. 25 is a schematic diagram showing the data structure of the rendering request queue 2402. As shown in FIG. 25, the rendering request queue 2402 includes an object number 2501, region information/parallax 2502, and image data 2503. The object number 2501 indicates the number of objects to be overlaid. The region information/parallax 2502 indicates an object-overlaying region on a left-view video image constituting main-view data, and parallax for the object-overlaying region. The image data 2503 indicates image data for each object. The image data 2503 is overlaid on each of the left-view video image and the right-view video image.

<2.2.2 Video Processing Unit 2403>

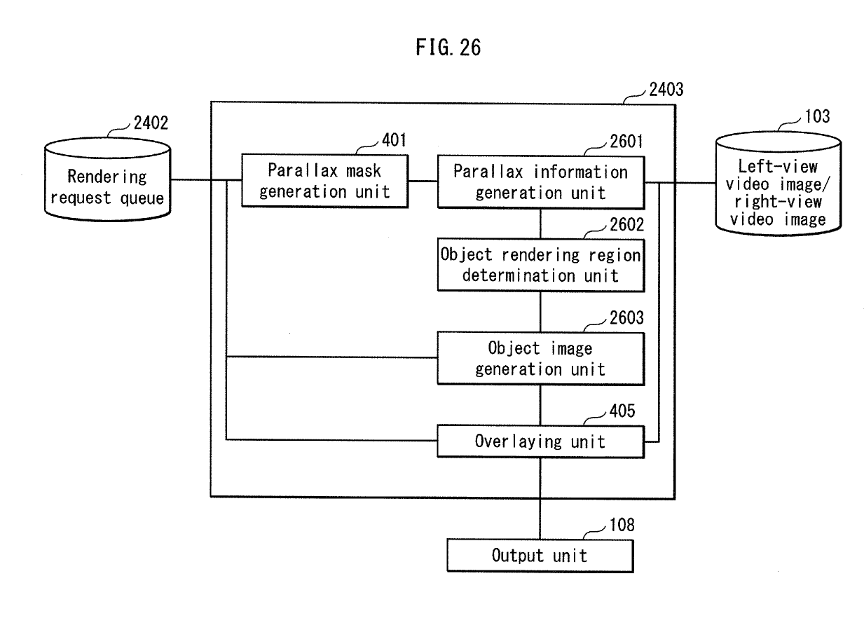

FIG. 26 is a block diagram showing an example of the inner structure of the video processing unit 2403. Components that are the same as the video processing unit 107 according to Embodiment 1 are provided with the same reference signs, and a description thereof is omitted. Below, structural differences from the video processing unit 107 are described. As shown in FIG. 26, the video processing unit 2403 includes the parallax mask generation unit 401, a parallax information generation unit 2601, an object rendering region determination unit 2602, an object image generation unit 2603, and the overlaying unit 405.

The parallax information generation unit 2601 is described first. Although the parallax information generation unit according to Embodiment 1 performs calculation of parallax using the parallax calculation formula for pixels other than a feature point, the parallax information generation unit 2601 differs from the parallax information generation unit according to Embodiment 1 in that calculation of parallax using the parallax calculation formula is performed also for the feature point. The following describes a reason why calculation of parallax using the parallax calculation formula is performed for all the pixels in the region indicated by the parallax mask including the feature point, with reference to the drawings.

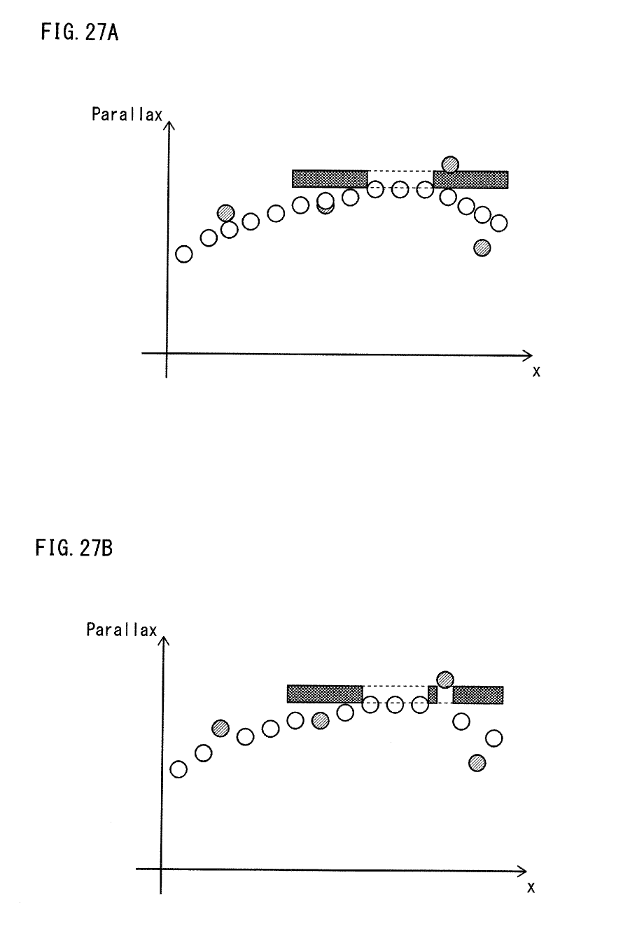

FIGS. 27A and 27B are illustrations each showing overlaying of an object performed by the video processing device 2400. The horizontal and vertical axes are respectively an x coordinate of a pixel and parallax for the pixel. Hatched circles each show parallax for a feature point, and the other circles each show parallax for a pixel calculated using the parallax calculation formula.

In the present embodiment, since the parallax calculation formula is also applied to a feature point and an object is overlaid using the results of the calculation, the object is overlaid as shown in FIG. 27A. On the other hand, in a case where an object is overlaid without applying the parallax calculation formula to a feature point, the object is overlaid as shown in FIG. 27B. As shown in FIG. 27B, when there is a gap between a value of parallax calculated using the parallax calculation formula and a value of parallax calculated for each of feature points by performing a search for corresponding points, and parallax for a certain feature point is larger than parallaxes for the other pixels, an object is not overlaid at a pixel corresponding to the certain feature point, and a phenomenon such as a dot defect occurs. In the present embodiment, in order to avoid occurrence of such a phenomenon, calculation of parallax using the parallax calculation formula is performed for all the pixels in the region indicated by the parallax mask including the feature point, and overlaying of an object is performed based on a value of the calculated parallax. This concludes the description of the parallax information generation unit 2601. The object rendering region determination unit 2602 is described next.

The object rendering region determination unit 2602 determines an object-rendering region in which an object is to be rendered in the overlaying of the object. Specifically, the object rendering region determination unit 2602 first compares a value of parallax to be provided to the object, which is stored in the rendering request queue 2402, and a value of parallax for the region on a left-view video image indicated by the parallax mask, which is calculated by the parallax information generation unit 2601. The object rendering region determination unit 2602 determines, as the object-rendering region, a region which is included in the region indicated by the parallax mask and in which parallax for the left-view video image is smaller than parallax for the object. A region in which parallax for the left-view video image is larger than parallax for the object does not fall under the object-rendering region. This concludes the description of the object rendering region determination unit 2602. The object image generation unit 2603 is described next.

The object image generation unit 2603 generates an object image based on the object-rendering region determined by the object rendering region determination unit 2602.

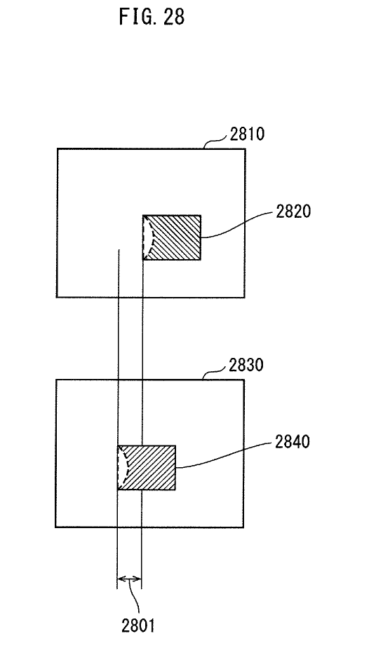

FIG. 28 is an illustration for explaining generation of the object image. Regions indicated by dotted lines are regions in each of which parallax for the left-view video image is larger than parallax for the object. As shown in FIG. 28, the object image generation unit 2603 generates a right-view object 2820 with respect to a region which is included in a region indicated by the rendering request queue 2402 and in which parallax for the left-view video image is smaller than parallax for the object, based on the object-rendering region determined by the object rendering region determination unit 2602.

The object image generation unit 2603 also generates a right-view object image 2830 by shifting the object 2820 to the left by an amount of parallax 2801 stored in the rendering request queue 2402.

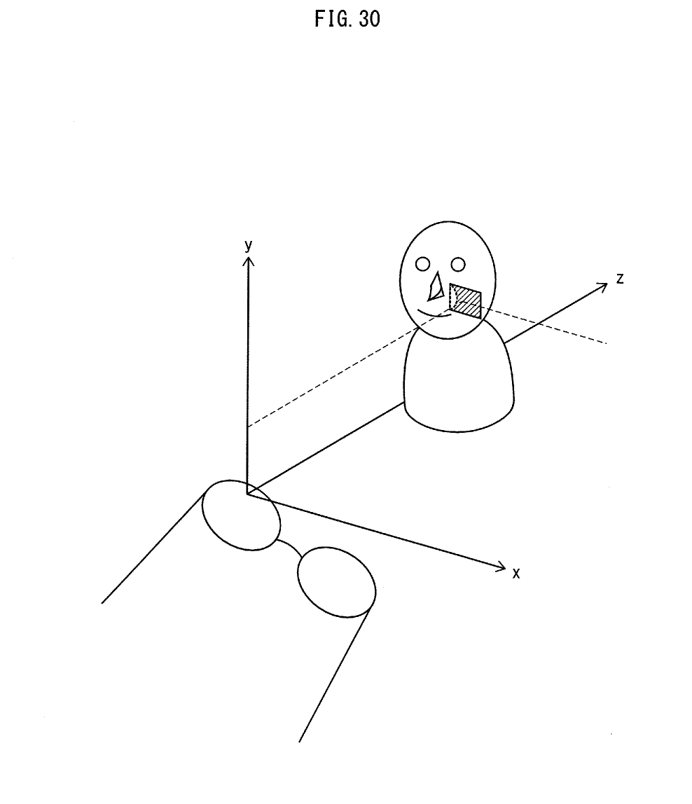

FIG. 30 shows stereoscopic viewing of a stereoscopic video image after overlaying. As shown in FIG. 30, since the object is not overlaid in the region in which the amount of parallax is larger than the predetermined amount of parallax to be provided to the object, it is possible to prevent such a condition that the stereoscopic video image appears to project forward from the object and the object appears to be buried within the stereoscopic video image, and a viewer can view the stereoscopic video image and the object overlaid on the stereoscopic video image without a sense of awkwardness.

This concludes the description of the structure of the video processing device 2400. An operation of the video processing device 2400 having the above-mentioned structure is described next.

<2.3 Operation>

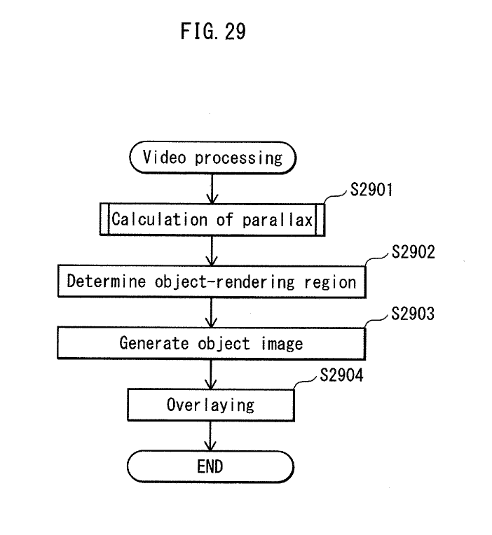

Video processing different from the video processing device 100 according to Embodiment 1 is described. FIG. 29 is a flow chart showing the video processing performed by the video processing device 2400. Operations that are the same as the video processing according to Embodiment 1 shown in FIG. 22 are provided with the same reference signs.

The parallax information generation unit 2601 first calculates parallax between a left-view video image and a right-view video image for the object-overlaying region (step S2901). As mentioned above, the parallax information generation unit 2601 performs calculation of parallax using the parallax calculation formula for all the pixels including a feature point.

Then, the object rendering region determination unit 2602 compares a value of parallax to be provided to the object, which is stored in the rendering request queue 2402, and a value of parallax for the region on a left-view video image indicated by the parallax mask, which is calculated by the parallax information generation unit 2601, and determines the object-rendering region in the overlaying of the object (step S2902).

The object image generation unit 2603 generates a left-view object image and a right-view object image, based on the object-rendering region determined in the step S2902 and the value of parallax stored in the rendering request queue 2402 (step S2903).

The overlaying unit 405 overlays the left-view object image and the right-view object image on the left-view video image and the right-view video image, respectively (step S2904). This concludes the description of the operation of the video processing device 2400.

As described above, according to the present embodiment, a feature point is extracted from pixels constituting the object-overlaying region and a region near the object-overlaying region, parallax for the object-overlaying region is calculated based on parallax for the extracted feature point, and an object is not overlaid in the region in which the amount of parallax is larger than the predetermined amount of parallax to be provided to the object. With this structure, it is possible to prevent such a condition that a stereoscopic video image appears to project forward from the object and the object appears to be buried within the stereoscopic video image.

### Embodiment 3

<3.1 Overview>

A video processing device according to Embodiment 3 is similar to the video processing device 100 according to Embodiment 1 in that parallax for the object-overlaying region on a stereoscopic video image is calculated, but differs from the video processing device 100 in that the calculated parallax is converted into depth information indicating a position in a depth direction in 3D display. With this structure, the video processing device according to the present embodiment generates the depth information indicating the position in the depth direction in the 3D display from a set of image data pieces for a left-view video image and a right-view video image.

<3.2 Structure>

The video processing device according to Embodiment 3 differs from the video processing device 100 according to Embodiment 1 shown in FIG. 1 in the structure of the video processing unit. Components other than the video processing unit 107, i.e. the operation unit 101, the video acquisition unit 102, the left-view video image/right-view video image storage unit 103, the control unit 104, the object rendering request unit 105, the rendering request queue 106, and the output unit 108, have the same structure as those of the video processing device 100. The following describes the video processing device that is different from the video processing device 100.

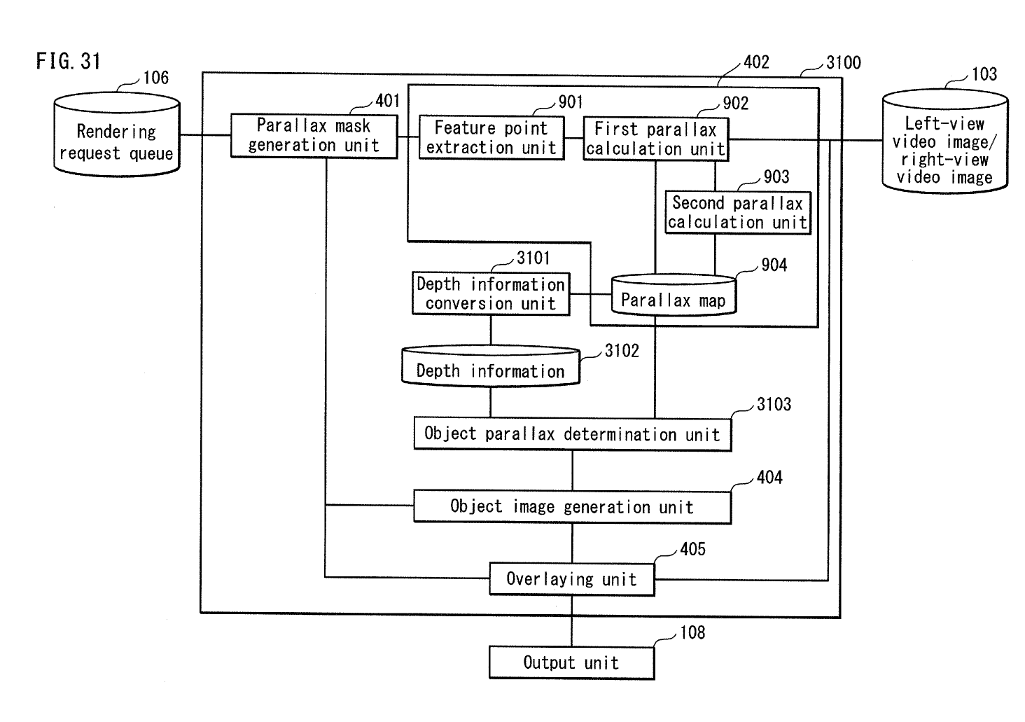

FIG. 31 is a block diagram showing an example of the inner structure of a video processing unit 3100 according to Embodiment 3. Components that are the same as the components of the video processing unit 107 according to Embodiment 1 shown in FIGS. 4 and 9 are provided with the same reference signs, and a description thereof is omitted. Below, structural differences from the video processing unit 107 are described. As shown in FIG. 31, the video processing unit 3100 includes the parallax mask generation unit 401, the parallax information generation unit 402, a depth information conversion unit 3101, a depth information storage unit 3102, an object parallax determination unit 3103, the object image generation unit 404, and the overlaying unit 405. The parallax information generation unit 402 includes the feature point extraction unit 901, the first parallax calculation unit 902, the second parallax calculation unit 903, and the parallax map storage unit 904.

<3.2.1 Depth Information Conversion Unit 3101 and Depth Information Storage Unit 3102>

The depth information conversion unit 3101 converts parallax into depth information. The depth information storage unit 3102 stores therein the depth information generated by the depth information conversion unit 3101.

The depth information indicates a position of a subject appears in image data in the depth direction in 3D display. In a stereoscopic video image, as the value of parallax increases, a subject is located further forward in the depth direction in 3D display. In contrast, as the value of parallax decreases, a subject is located further backward in the depth direction in 3D display. That is to say, the value of parallax is proportional to a distance in the depth direction.

The depth information conversion unit 3101 therefore stores the value of parallax stored in the parallax map 904 in the depth information storage unit 3102 as the depth information.

Instead of storing the value of parallax stored in the parallax map 904 in the depth information storage unit 3102 as the depth information, the depth information conversion unit 3101 may store, in the depth information storage unit 3102, a value obtained by performing scaling and shifting of the value of parallax stored in the parallax map 904, as the depth information.

The depth information conversion unit 3101 performs scaling and shifting of the value of parallax using the following formula, for example.

Depth information=amount of parallax×α+β

Here, a weight parameter for scaling α and a weight parameter for shifting β are each a given set value. For example, α and β may satisfy: α=255/(maximum amount of parallax−minimum amount of parallax), β=0. Values of α and β may be input by a user of the video processing device.

Instead of performing both of scaling (multiplication of a weight parameter) and shifting (addition of a weight parameter), only one of them may be performed.

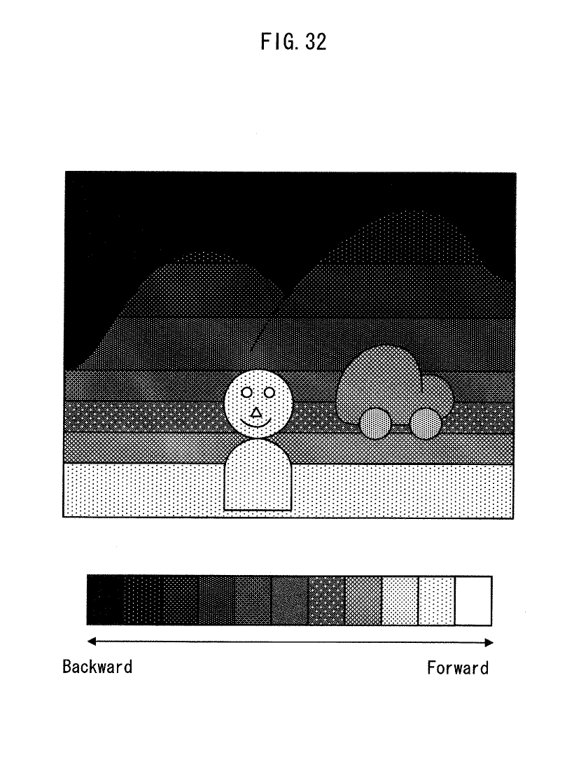

The depth information thus calculated is stored in the depth information 3102 in association with each pixel constituting image data. For example, the depth information may be stored as image data representing the depth by brightness as shown in FIG. 32. In an example shown in FIG. 32, as an image is located further forward, the color becomes whiter, whereas the color becomes blacker as an image is located further backward.

<3.2.2 Object Parallax Determination Unit 3103>

The object parallax determination unit 3103 detects a maximum amount of parallaxes for respective pixels in the object-overlaying region, and determines the detected maximum amount of parallax as the amount of parallax for an object. In this case, the object parallax determination unit 3103 generates the value of parallax from the depth information stored in the depth information storage unit 3102, and determines parallax for an object to be overlaid using the generated value of parallax.

When the depth information stored in the depth information storage unit 3102 is the depth information indicating the value of parallax stored in the parallax map 904, the object parallax determination unit 3103 determines parallax for the object to be overlaid using the value of the depth information stored in the depth information storage unit 3102 as the value of parallax.

When the depth information stored in the depth information storage unit 3102 is the value obtained by performing scaling and/or shifting of the value of parallax stored in the parallax map 904, the object parallax determination unit 3103 generates the value of parallax from the depth information by reversing an operation used to perform scaling and/or shifting of the value of parallax. For example, when scaling and shifting are performed using the formula “depth information=amount of parallax×α+β” described in the section <3.2.1>, the value of parallax is generated from the depth information using the following formula.

Amount of parallax=(depth information−β)/α

The object parallax determination unit 3103 may determine parallax for an object to be overlaid using the value of parallax stored in the parallax map storage unit 904, similarly to the video processing device 100 according to Embodiment 1.

This concludes the description of the structure of the video processing unit 3100. An operation of the video processing device 3100 having the above-mentioned structure is described next.

<3.3 Operation>

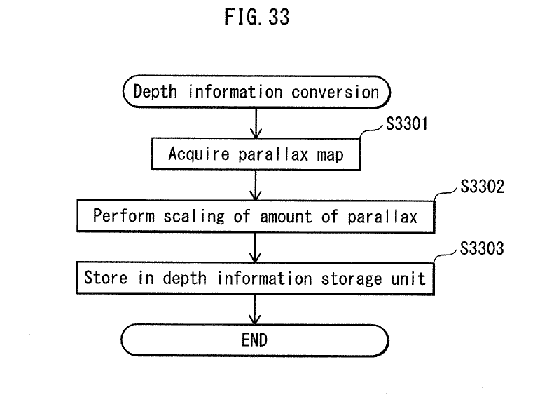

Depth information conversion different from the video processing device 100 according to Embodiment 1 is described. FIG. 33 is a flow chart showing depth information conversion performed by the video processing unit 3100.

As shown in FIG. 33, the depth information conversion unit 3101 acquires parallax stored in the parallax map 904 (step S3301).

The depth information conversion unit 3101 then performs scaling and/or shifting of the acquired amount of parallax (step S3302). In this example, scaling and/or shifting are/is performed using the formula “depth information=amount of parallax×α+β” described in the section <3.2.1>.

The depth information conversion unit 3101 stores the value calculated by performing scaling and/or shifting of the amount of parallax in the depth information storage unit 3102 as the depth information (step S3303).

When, instead of storing the value obtained by performing scaling and/or shifting of the amount of parallax in the depth information storage unit 3102 as the depth information, the amount of parallax stored in the parallax map 904 is stored in the depth information storage unit 3102 as the depth information, the above-mentioned processing in the step S3302 is not performed. This concludes the description of the operation of the video processing unit 3100.

As described above, the video processing device according to the present embodiment generates the depth information indicating a position in the depth direction in the 3D display from a set of image data pieces for a left-view video image and a right-view video image. Since the depth information is generated from parallax calculated by the parallax information generation unit 402 with speed and accuracy, it is possible to generate the depth information indicating a position in the depth direction in the 3D display with speed and accuracy.

### Embodiment 4

<4.1 Overview>

A video processing device according to Embodiment 4 is similar to the video processing device according to Embodiment 3 in that the depth information indicating a position in the depth direction in the 3D display is generated from a set of image data pieces for a left-view video image and a right-view video image, but differs from the video processing device according to Embodiment 3 in the contents of the depth information to be generated. The video processing device according to the present embodiment generates an actual distance in the depth direction from an image-capturing position of image data to a subject appearing in the image data, from a set of image data pieces for a left-view video image and a right-view video image.

<4.2 Structure>

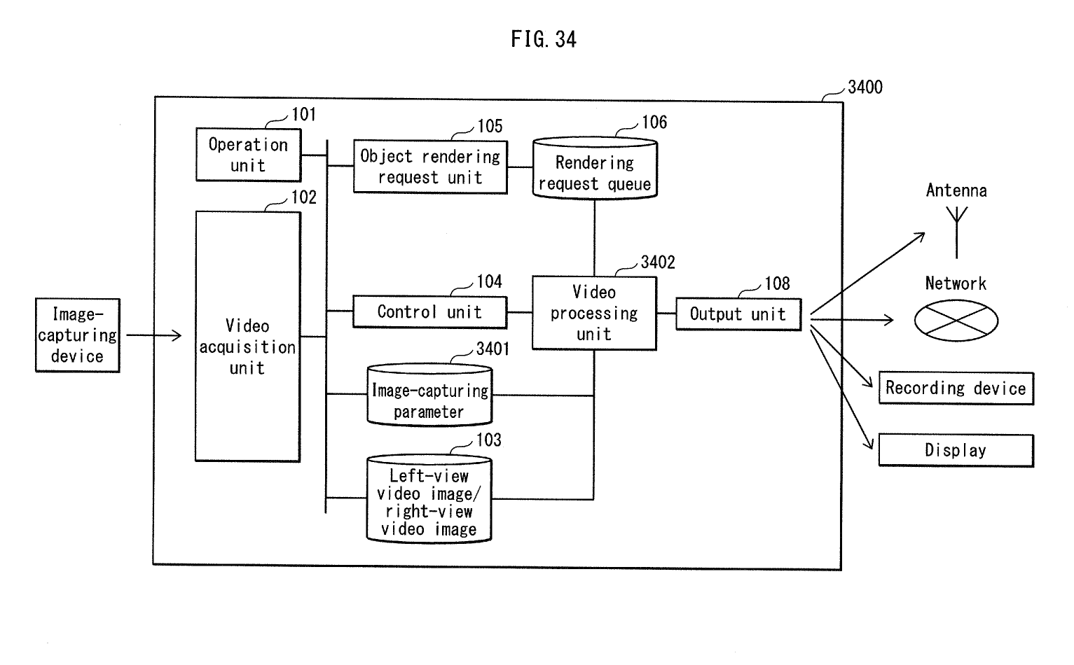

FIG. 34 is a block diagram showing an example of the structure of a video processing device 3400 according to Embodiment 4. Components that are the same as the video processing device 100 according to Embodiment 1 shown in FIG. 1 are provided with the same reference signs, and a description thereof is omitted. Below, structural differences from the video processing unit 100 are described. As shown in FIG. 34, the video processing device 3400 includes the operation unit 101, the video acquisition unit 102, the left-view video image/right-view video image storage unit 103, an image-capturing parameter storage unit 3401, the control unit 104, the object rendering request unit 105, the rendering request queue 106, a video processing unit 3402, and the output unit 108.

<4.2.1 Image-Capturing Parameter Storage Unit 3401>

The image-capturing parameter storage unit 3401 stores therein parameter information relating to a camera for capturing a left-view video image and a camera for imaging a right-view video image. The image-capturing parameter includes, for example, information indicating an angle of view of a camera, resolution of an image shot by a camera, a base length indicating a linear distance from a camera for capturing a left-view video image to a camera for capturing a right-view video image. In place of the angle of view of a camera, information indicating a focal length and a frame size of a camera may be included.

The image-capturing parameter as described above is multiplexed into a stereoscopic video image acquired by the video acquisition unit 102 as ancillary information, for example, and is obtained by demultiplexing the acquired stereoscopic video image. The image-capturing parameter may be provided by an input from a user of the device. The image-capturing parameter may be provided by an external input.

<4.2.2 Video Processing Unit 3402>

The video processing unit 3402 calculates parallax for a set of a left-view video image and a right-view video image stored in the left-view video image/right-view video image storage unit 103. The video processing unit 3402 converts the calculated parallax into an actual distance in the depth direction from an image-capturing position of image data to a subject appearing in the image data, using the image-capturing parameter stored in the image-capturing parameter storage unit 3401.

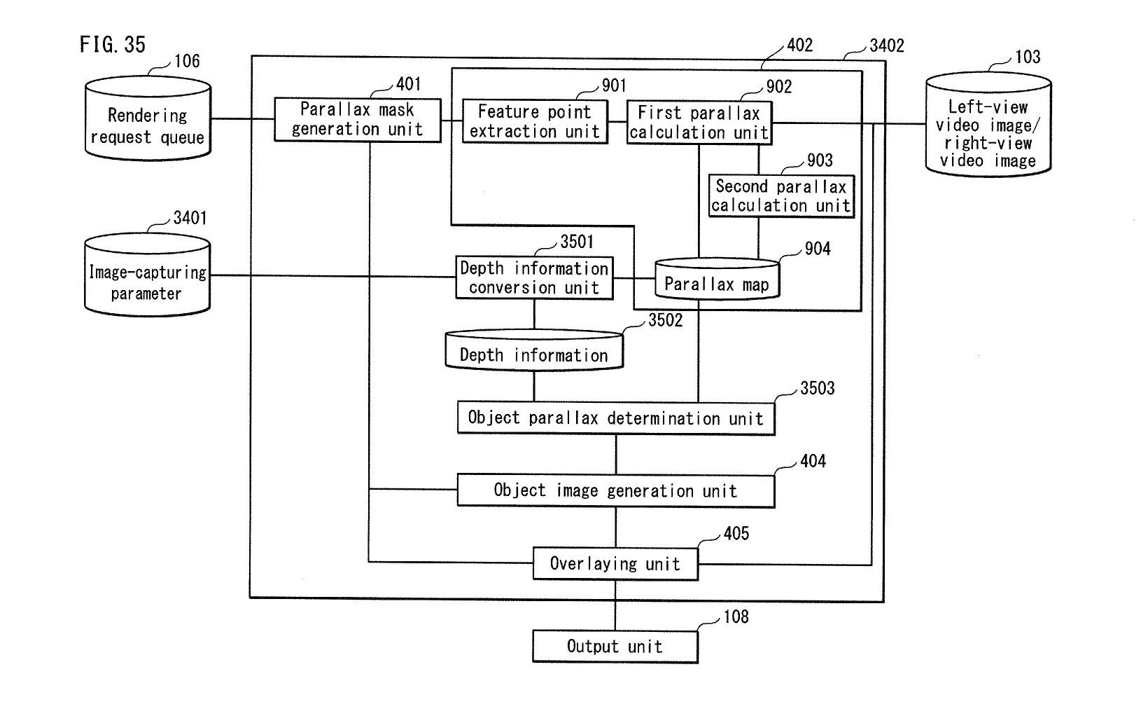

FIG. 35 is a block diagram showing an example of the inner structure of the video processing unit 3402. Components that are the same as the video processing unit 107 according to Embodiment 1 shown in FIGS. 4 and 9 are provided with the same reference signs, and a description thereof is omitted. Below, structural differences from the video processing unit 107 are described. As shown in FIG. 35, the video processing unit 3402 includes the parallax mask generation unit 401, the parallax information generation unit 402, a depth information conversion unit 3501, a depth information storage unit 3502, an object parallax determination unit 3503, the object image generation unit 404, and the overlaying unit 405. The parallax information generation unit 402 includes the feature point extraction unit 901, the first parallax calculation unit 902, the second parallax calculation unit 903, and the parallax map storage unit 904.

<4.2.2.1 Depth Information Conversion Unit 3501 and Depth Information Storage Unit 3502>

The depth information conversion unit 3501 converts parallax into depth information. The depth information storage unit 3502 stores therein the depth information generated by the depth information conversion unit 3501.

In the present embodiment, the depth information conversion unit 3501 converts parallax into an actual distance from an image-capturing position to a subject using an image-capturing parameter, and stores information indicating the actual distance obtained after conversion in the depth information storage unit 3502 as the depth information.

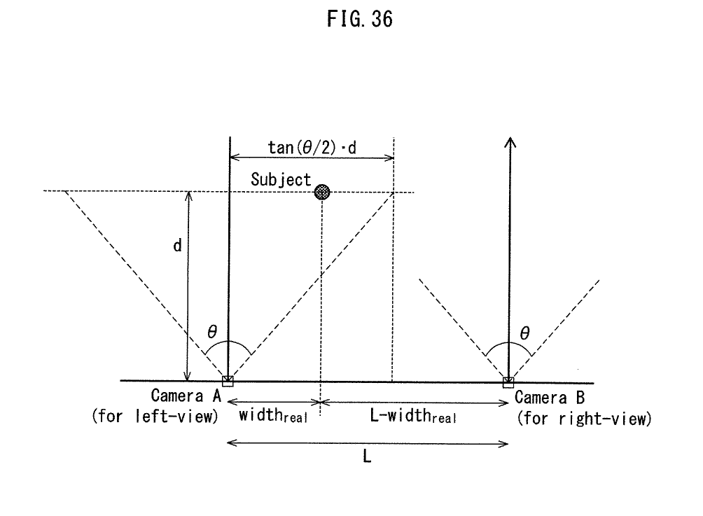

FIG. 36 shows a positional relationship among cameras and a subject. Considered in this embodiment is a paralleling method in which a subject is shot in a state where an optical axis of a left camera is parallel to an optical axis of a right camera. In FIG. 36, d denotes an actual distance in a depth direction from an image-capturing position to a subject, θ denotes a horizontal angle of view (an angle from the left to right edge of a frame), L denotes a base length (a linear distance from a camera for capturing a left-view video image to a camera for capturing a right-view video image), and widthᵣₑₐₗ denotes an actual distance from an optical axis to a subject.

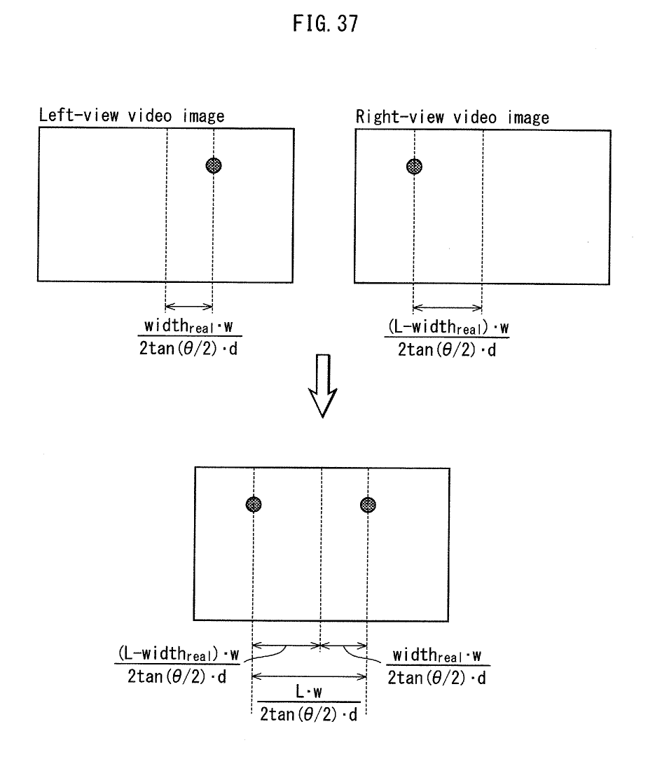

FIG. 37 shows a relationship between parallax and an actual distance. In FIG. 37, w denotes the width (the number of pixels) of each of a left-view video image and a right-view video image.

Referring to FIG. 36, an actual distance between a subject positioned at an edge of a frame and a subject at the center of the frame is tan(θ/2)·d. The number of pixels per unit actual distance is therefore w/2 tan(θ/2)·d.

As shown in FIG. 37, the number of pixels from the center of the left-view video image to the subject is therefore widthᵣₑₐₗ·w/2 tan(θ/2)·d. Similarly, the number of pixels from the center of the right-view video image to the subject is (L-widthᵣₑₐₗ)·w/2 tan(θ/2)·d. Accordingly, parallax DP for a set of the left-view video image and the right-view video image is expressed in the following formula.

$$d = \frac{L}{2 tan ( θ / 2 )} \cdot \frac{1}{d} \cdot w \qquad [ Formula 2 ]$$

The actual distance d in a depth direction from the image-capturing position to the subject is expressed in the following formula, using the parallax DP.

$$d = \frac{L}{2 tan ( θ / 2 )} \cdot \frac{1}{DP} \cdot w \qquad [ Formula 3 ]$$

Information indicating the horizontal angle of view θ, the base length L, and the pixel width w of an image in the above-mentioned formula is stored in the image-capturing parameter storage unit 3401 as the image-capturing parameter. The depth information conversion unit 3501 acquires the image-capturing parameter from the image-capturing parameter storage unit 3401, acquires information indicating parallax from the parallax map storage unit 904, and calculates the actual distance in a depth direction from the image-capturing position to the subject using the relationship expressed in the above formula.

When the image-capturing parameter storage unit 3401 stores, in place of an angle of view of a camera, information indicating a focal length and a frame size of a camera as the image-capturing parameter, the actual distance in a depth direction from an image-capturing position to a subject is calculated using the information indicating the focal length and the frame size of the camera. Specifically, the angle of view of the camera is calculated from the information indicating the focal length and the frame size of the camera. The actual distance in a depth direction from the image-capturing position to the subject is then calculated from Formula 3 shown above, using the calculated angle of view.

<4.2.2.2 Object Parallax Determination Unit 3503>

The object parallax determination unit 3503 detects a maximum amount of parallaxes for respective pixels in the object-overlaying region, and determines the detected maximum amount of parallaxes as the amount of parallax for an object to be overlaid. In this case, the object parallax determination unit 3503 generates the value of parallax from the depth information stored in the depth information storage unit 3502, and determines parallax for the object using the generated value of parallax.

Specifically, the object parallax determination unit 3503 generates parallax from the depth information, using a relationship between the parallax DP and the actual distance d in a depth direction from the image-capturing position to the subject expressed in Formula 2.

The object parallax determination unit 3503 may determine parallax for the object using the value of parallax stored in the parallax map storage unit 904, similarly to the video processing device 100 according to Embodiment 1.

<4.3 Operation>

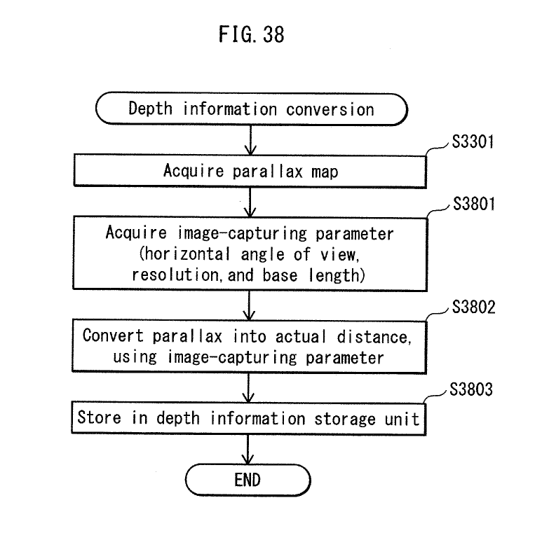

Depth information conversion different from the video processing device 100 according to Embodiment 1 is described. FIG. 38 is a flow chart showing depth information conversion performed by the video processing device 3400.

As shown in FIG. 38, the depth information conversion unit 3501 acquires parallax stored in the parallax map 904 (step S3301).

The depth information conversion unit 3501 then acquires an image-capturing parameter including a horizontal angle of view, resolution, and a base length stored in the image-capturing parameter storage unit 3401 (step S3801).

The depth information conversion unit 3501 converts parallax into an actual distance in a depth direction from an image-capturing position of image data to a subject appearing in the image data, using the image-capturing parameter (step S3802). Conversion described above is performed for each pixel constituting the image data.

The depth information conversion unit 3501 stores a value of the actual distance in a depth direction from the image-capturing position of the image data to the subject appearing in the image data, which is calculated from the value of parallax, in the depth information storage unit 3502 as the depth information (step S3803). This concludes the description of the operation of the video processing device 3400.

As described above, the video processing device 3400 according to the present embodiment generates an actual distance in a depth direction from an image-capturing position of image data to a subject appearing in the image data, from a set of image data pieces for a left-view video image and a right-view video image. Since the actual distance in a depth direction from the image-capturing position of the image data to the subject appearing in the image data is calculated using parallax calculated by the parallax information generation unit 402 with speed and accuracy, it is possible to calculate the actual distance in a depth direction from the image-capturing position of the image data to the subject appearing in the image data with speed and accuracy.

### Embodiment 5

A video processing device according to Embodiment 5 is similar to the video processing device according to Embodiment 4 in that an actual distance in a depth direction from an image-capturing position of image data to a subject appearing in the image data is calculated, from a set of data pieces for a left-view video image and a right-view video, but differs from the video processing device according to Embodiment 4 in that the actual distance is calculated considering an amount of plane shifting performed on the left-view video image and the right-view video image.

Plane shifting is described first. Plane shifting is performed to change the depth in a stereoscopic video image by shifting coordinates of pixels in each line on plane memory to the left or to the right.

Depending on shooting conditions and a position of a subject, parallax between a left-view video image and a right-view video image respectively shot by left and right cameras may become large. A stereoscopic video image having extremely large parallax is known to have a possibility of causing viewer's eyestrain, feeling of discomfort, visually induced motion sickness, and the like. By performing plane shifting on a set of a left-view video image and a right-view video image having large parallax, the amount of parallax is reduced.

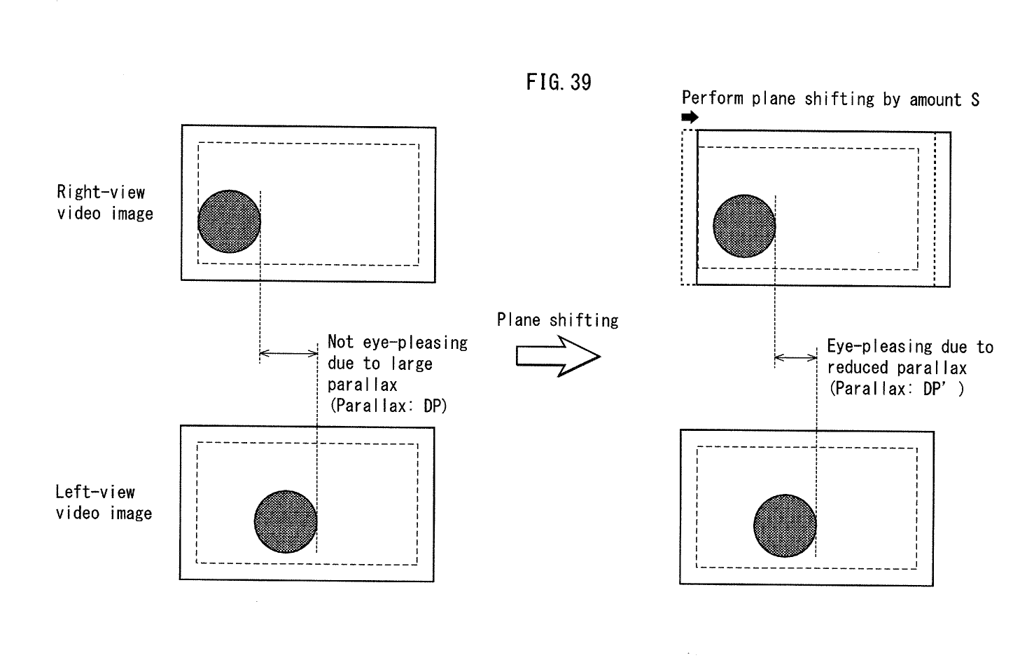

FIG. 39 is an illustration for explaining plane shifting. Regions enclosed by solid lines indicate regions shot by a camera, and regions enclosed by dotted lines indicate regions actually recorded as image data.

In an example shown in FIG. 39, plane shifting is performed on a set of a left-view video image and a right-view video image having large parallax by shifting the right-view video image by an amount S to the right. This reduces parallax between the left-view video image and the right-view video image after plane shifting, and provides a viewer with eye-pleasing stereoscopic video images. The following formula holds true between parallax DP before plane shifting and parallax DP′ after plane shifting.

DP=DP′−S

As described above, when plane shifting is performed on a left-view video image and a right-view video image, the value of parallax stored in the parallax map storage unit 904 is not parallax DP between subjects appearing in image data actually shot but parallax DP′ between subjects appearing in image data after plane shifting.

In order to calculate an actual distance in a depth direction from an image-capturing position to a subject, however, parallax DP indicating a positional relationship between subjects appearing in image data actually shot is required. Therefore, the depth information conversion unit according to the present embodiment calculates parallax DP using the plane shift amount S, and calculates the actual distance in a depth direction from the image-capturing position to the subject.

The actual distance d in a depth direction from the image-capturing position to the subject is expressed in the following formula, using the parallax DP′ and the plane shift amount S.

$$d = \frac{L}{2 tan ( θ / 2 )} \cdot \frac{1}{{DP}^{′} - S} \cdot w \qquad [ Formula 4 ]$$

In Embodiment 4, the actual distance in a depth direction from the image-capturing position to the subject is calculated from parallax using an image-capturing parameter including an angle of view, resolution, and a base length. In the present embodiment, in addition to the angle of view, the resolution, and the base length, an image-capturing parameter including a plane shift amount is required.

The image-capturing parameter including a plane shift amount is multiplexed into a stereoscopic video image acquired by the video acquisition unit 102 as ancillary information, for example, and is obtained by demultiplexing the acquired stereoscopic video image. The image-capturing parameter including a plane shift amount may be provided by an input from a user of the device. The image-capturing parameter including a plane shift amount may be provided by an external input. The acquired plane shift amount is stored in the image-capturing parameter storage unit.

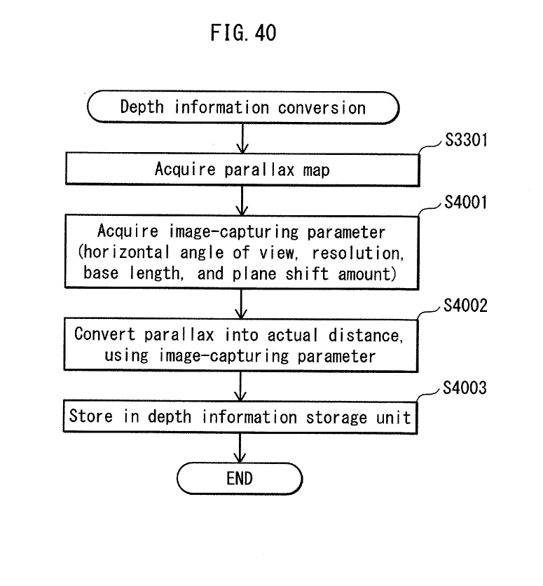

The following describes actual distance calculation performed by the video processing device according to the present embodiment. FIG. 40 is a flow chart showing actual distance calculation according to the present embodiment.

As shown in FIG. 40, the depth information conversion unit 3501 acquires parallax stored in the parallax map 904 (step S3301).

The depth information conversion unit 3501 then acquires an image-capturing parameter including a horizontal angle of view, resolution, a base length, and a plane shift amount stored in the image-capturing parameter storage unit 3401 (step S4001).

The depth information conversion unit 3501 converts parallax into the actual distance in a depth direction from the image-capturing position of image data to the subject appearing in the image data, using the image-capturing parameter including the horizontal angle of view, the resolution, the base length, and the plane shift amount (step S4002). Specifically, the actual distance in a depth direction to the subject appearing in the image data is calculated using Formula 4. Conversion described above is performed for each pixel constituting the image data.

The depth information conversion unit 3501 stores a value of the actual distance in a depth direction from the image-capturing position of the image data to the subject appearing in the image data, which is calculated from the value of parallax, in the depth information storage unit 3502 as the depth information (step S4003). This concludes the description of the operation of the video processing device according to the present embodiment.

As described above, the video processing device according to the present embodiment calculates the actual distance in a depth direction from the image-capturing position to the subject, from a set of image data pieces for a left-view video image and a right-view video image on each of which plane shifting has been performed. Since the actual distance in a depth direction from the image-capturing position to the subject is calculated using parallax calculated by the parallax information generation unit 402 with speed and accuracy, it is possible to calculate the actual distance in a depth direction from the image-capturing position to the subject with speed and accuracy.

<<Supplemental Note>>

While the present invention has been described according to the above embodiments, the present invention is in no way limited to these embodiments. The present invention also includes cases such as the following.

(a) The present invention may be an application execution method as disclosed by the processing steps described in the embodiments. The present invention may also be a computer program that includes program code causing a computer to perform the above processing steps.

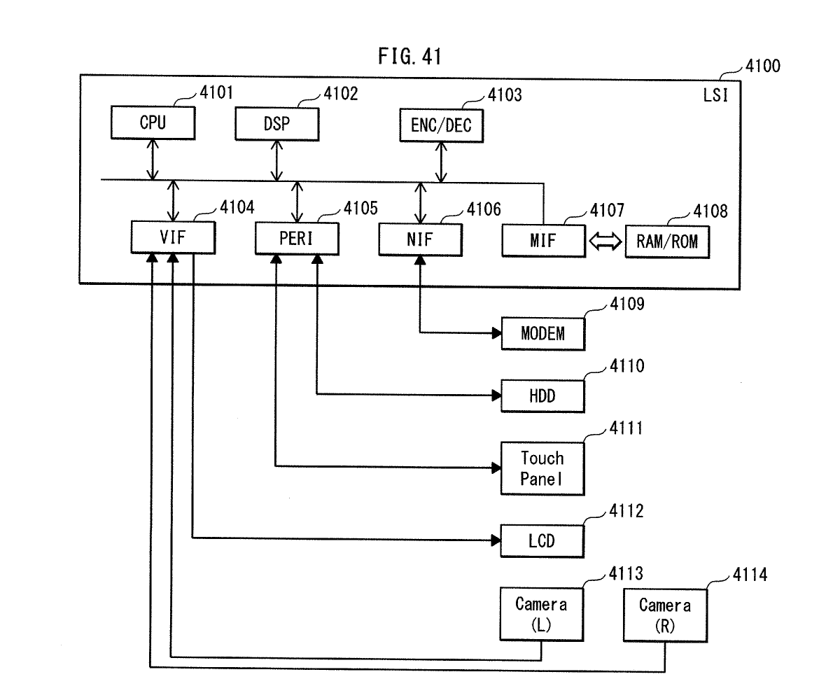

(b) The present invention may be configured as an IC, LSI, and other integrated circuit packages performing execution control over applications. FIG. 41 shows an example in which the video processing device according to the present invention is embodied using LSI. As shown in FIG. 41, LSI 4100 includes a CPU (Central Processing Unit) 4101, a DSP (Digital Signal Processor) 4102, an ENC/DEC (Encoder/Decoder) 4103, a VIF (Video Interface) 4104, a PERI (Peripheral Interface) 4105, an NIF (Network Interface) 4106, an MIF (Memory Interface) 4107, and RAM/ROM (Random Access Memory/Read Only Memory) 4108, for example.

The processing steps described in the embodiments are stored in the RAM/ROM 4108 as program code. The program code stored in the RAM/ROM 4108 is read via the MIF 4107, and executed by the CPU 4101 or the DSP 4102. The functions of the video processing device described in the embodiments are implemented in this way.

The VIF 4104 is connected to an image-capturing device, such as a Camera (L) 4113 and a Camera (R) 4114, and a display device, such as an LCD (Liquid Crystal Display) 4112, to acquire and output a stereoscopic video image. The ENC/DEC 4103 encodes/decodes a stereoscopic video image as acquired or generated. The PERI 4105 is connected to a recording device, such as an HDD (Hard Disk Drive) 4110, and an operating device, such as a touch panel 4111, and performs control over these peripheral devices. The NIF 4106 is connected to a MODEM 4109 and the like, and establishes a connection with an external network.

Such a package is used by being incorporated into various devices, and thus the various devices implement functions described in the embodiments. The method of integration is not limited to LSI, and a dedicated communication circuit or a general-purpose processor may be used. A FPGA (Field Programmable Gate Array), which is LSI that can be programmed after manufacture, or a reconfigurable processor, which is LSI whose connections between internal circuit cells and settings for each circuit cell can be reconfigured, may be used. Additionally, if technology for integrated circuits that replaces LSI emerges, owing to advances in semiconductor technology or to another derivative technology, the integration of functional blocks may naturally be accomplished using such technology. Among such technology, the application of biotechnology or the like is possible.

While referred to here as LSI, depending on the degree of integration, the terms IC, system LSI, super LSI, or ultra LSI are also used.

(c) In Embodiments 1, 2, 3, 4, and 5, a stereoscopic video image targeted for the processing is a two-view image including a set of a left-view video image and a right-view video image. The stereoscopic video image, however, may be a multi-view image obtained by shooting a subject from three or more views. Similar video processing can be performed on the multi-view image from three or more views.

(d) In Embodiments 1, 2, 3, 4, and 5, the stereoscopic video image acquired by the video acquisition unit 102 is a stereoscopic video image captured in real time with an image-capturing device connected to the video processing device 100. As the stereoscopic video image, however, a stereoscopic video image captured in real time at a remote location may be acquired over the network. Alternatively, a stereoscopic video image recorded in a server may be acquired over the network. Furthermore, television broadcast and the like may be acquired via an antenna. The stereoscopic video image may be recorded on a recording device external to or internal to the video processing device 100. The recording device includes an optical disc, such as a hard disk drive, BD, and DVD, and a semiconductor memory device, such as an SD memory card.

(e) In Embodiments 1, 2, 3, 4, and 5, the region to which the parallax calculation formula is applied is the hatched region shown in FIG. 15. The region to which the parallax calculation formula is applied, however, may be any region that is specifiable from sampling points. For example, coordinates of a center of sampling points may be considered as an average value of coordinates of the sampling points, and a region within a specific distance from the center may be considered as the region to which the parallax calculation formula is applied. As the specific distance, a value proportional to a variance value of the sampling points may be used.

(f) In Embodiments 1, 2, 3, 4, and 5, as shown in FIG. 9, the feature point index 902 included in the sampling point information 504 is an array of fixed length. The feature point index 902, however, may be an array of variable length or may have the structure other than an array, such as a list structure.

(g) In Embodiment 1, a maximum amount of parallaxes for respective pixels in the object-overlaying region is determined as the amount of parallax for the object. The amount of parallax for the object, however, may be the amount obtained by adding a predefined offset amount to the maximum amount of parallaxes for the respective pixels in the object-overlaying region.

(h) In Embodiments 1, 2, 3, 4, and 5, coordinates of the object-overlaying region indicated by the rendering request queue are coordinates on a left-view video image, and a feature point is extracted from the left-view video image. The coordinates of the object-overlaying region, however, may be coordinates on a right-view video image, and a feature point may be extracted from the right-view video image.

(i) In Embodiments 1, 2, 3, 4, and 5, in order to calculate parallax for pixels other than a feature point in the object-overlaying region based on parallax for the feature point, a parameter of the parallax estimation model shown in Formula 1 is determined by a least squares method to derive the parallax calculation formula. The method for calculating parallax for pixels other than a feature point, however, may not be limited to this method. For example, the parameter of the parallax estimation model may be calculated by a least squares method with respect to a low order expression or higher order expression, or a weighted least squares method. Other estimation models may be used instead.

Alternatively, a plurality of estimation models may be prepared, and, from among the estimation models, any suitable estimation model may be selected according to a type of a stereoscopic video image targeted for overlaying.

(j) In Embodiments 1, 2, 3, 4, and 5, the object rendering request unit generates the rendering request queue based on the contents, the position, and the like of object data, such as graphics, a symbol, and a letter, to be overlaid on a stereoscopic video image designated through the operation unit. The rendering request queue, however, may be generated based on an event acquired, over the network and the like, from an application of an external device that receives an input from a user.

By transmitting a stereoscopic video image after overlaying to the external device, overlaying is performed interactively over the network.

(k) The above embodiments and modifications may be combined with one another.

### INDUSTRIAL APPLICABILITY

The video processing device according to the present invention extracts a feature point from pixels constituting a region targeted for calculation of parallax and a region near the targeted region, and calculates, using the extracted feature point, parallax for each pixel constituting the targeted region. The video processing device is therefore useful because parallax for the targeted region on a stereoscopic video image is calculated with speed and accuracy.

### REFERENCE SIGNS LIST

100 video processing device
101 operation unit
102 video acquisition unit
103 left-view video image/right-view video image storage unit
104 control unit
105 object rendering request unit
106 rendering request queue
107 video processing unit
108 output unit
401 parallax mask generation unit
402 parallax information generation unit
403 object parallax determination unit
404 object image generation unit
405 overlaying unit
901 feature point extraction unit
902 first parallax calculation unit
903 second parallax calculation unit
904 parallax map storage unit
2400 video processing device
2401 object rendering request unit
2402 rendering request queue
2403 video processing unit
2601 parallax information generation unit
2602 object rendering region determination unit
2603 object image generation unit
3100 video processing unit
3101 depth information conversion unit
3102 depth information storage unit
3103 object parallax determination unit
3400 video processing device
3401 image-capturing parameter storage unit
3402 video processing unit
3501 depth information conversion unit
3502 depth information storage unit
3503 object parallax determination unit
4100 LSI
4101 CPU
4102 DSP
4103 ENC/DEC
4104 VIF
4105 PERI
4106 NIF
4107 MIF
4108 RAM/ROM
4109 MODEM
4110 HDD
4111 touch panel
4112 LCD
4113 Camera (L)
4114 Camera (R)

1-17. (canceled)

18. A video processing device for calculating an offset amount in a horizontal direction between corresponding pixels in a set of main-view data and sub-view data constituting a stereoscopic video image, comprising:
an offset mask generation unit configured to specify, as a region targeted for calculation of the offset amount, a region on the main-view data in which an object image is to be overlaid, and generate an offset mask indicating the targeted region;
a feature point extraction unit configured to limit a search range to the targeted region indicated by the offset mask and a region near the targeted region, and extract a predetermined number of feature points from the search range, each feature point being a characterizing pixel in the main-view data;
a first offset amount calculation unit configured to calculate the offset amount for each of the feature points by performing a search for corresponding feature points in the sub-view data; and
a second offset amount calculation unit configured to calculate the offset amount for each of pixels constituting the targeted region by using the offset amount calculated for each of the feature points.

19. The video processing device of claim 18, wherein
when the predetermined number of feature points are not found in the search range, the feature point extraction unit selects a region adjacent to the search range as a new search range and searches the new search range for a feature point, and
the selection and the search in the new search range are repeated until the predetermined number of feature points are extracted.

20. The video processing device of claim 18, wherein
the feature point extraction unit
divides the main-view data into a plurality of regions that meet at one pixel in the targeted region,
performs, for each divided region, the limitation of the search range and the extraction of the feature points, and
when feature points of a number predetermined for each divided region are not found in the search range in the divided region, selects a region adjacent to the search range as a new search range and searches the new search range for a feature point, and
the selection and the search in the new search range are repeated until the feature points of the number predetermined for the divided region are extracted.

21. The video processing device of claim 18, wherein
the second offset amount calculation unit calculates the offset amount for each pixel constituting the targeted region by deriving a formula indicating offset amount distribution in the targeted region from the offset amount calculated for each feature point.

22. The video processing device of claim 18, wherein
the search range includes one or more regions that are selected from among a plurality of regions obtained by dividing the main-view data and each include at least part of the targeted region.

23. The video processing device of claim 18 further comprising
an overlaying unit configured to respectively overlay the object image and an object image paired with the object image on the main-view data and the sub-view data, based on the offset amount for each pixel constituting the targeted region calculated by the first offset amount calculation unit or the second offset amount calculation unit.

24. The video processing device of claim 23, wherein
when respectively overlaying the object image and the paired object image on the main-view data and the sub-view data, the overlaying unit provides the object image with a maximum value of the offset amounts for respective pixels constituting the targeted region calculated by the first offset amount calculation unit or the second offset amount calculation unit.

25. The video processing device of claim 23, wherein
the overlaying unit compares the offset amount for each pixel constituting the targeted region calculated by the first offset amount calculation unit or the second offset amount calculation unit with the offset amount preset to the object image, and
the overlaying unit overlays the respective object images on the main-view data and the sub-view data with an exception of any pixel in the main-view data at which the offset amount is larger than the offset amount preset to the object image and a corresponding pixel in the sub-view data.

26. The video processing device of claim 18 further comprising
a depth information conversion unit configured to convert the offset amount calculated by the first offset amount calculation unit or the second offset amount calculation unit into depth information indicating a position in a depth direction in 3D display.

27. The video processing device of claim 26, wherein
the depth information conversion unit performs one or both of scaling and shifting of the offset amount calculated by the first offset amount calculation unit or the second offset amount calculation unit.

28. The video processing device of claim 26, wherein
the depth information indicates an actual distance in the depth direction from an image-capturing position to a subject.

29. The video processing device of claim 28, wherein
the depth information conversion unit converts the offset amount calculated by the first offset amount calculation unit or the second offset amount calculation unit into the depth information indicating the actual distance by using an image-capturing parameter of a camera for capturing the main-view data and a camera for capturing the sub-view data.

30. The video processing device of claim 29, wherein
the image-capturing parameter includes an angle of view and resolution of each of the camera for capturing the main-view data and the camera for capturing the sub-view data, and a base length from the camera for capturing the main-view data to the camera for capturing the sub-view data.

31. The video processing device of claim 29, wherein
the image-capturing parameter includes a focal length, a frame size, and resolution of each of the camera for capturing the main-view data and the camera for capturing the sub-view data, and a base length from the camera for capturing the main-view data to the camera for capturing the sub-view data.

32. The video processing device of claim 28, wherein
when plane shifting has been performed on the main-view data and the sub-view data, the depth information conversion unit converts the offset amount calculated by the first offset amount calculation unit or the second offset amount calculation unit into the offset amount between the corresponding pixels in the set of main-view data and the sub-view data before plane shifting, and calculates the actual distance based on the offset amount obtained as a result of the conversion.

33. A video processing method for calculating an offset amount in a horizontal direction between corresponding pixels in a set of main-view data and sub-view data constituting a stereoscopic video image, comprising:
an offset mask generation step of specifying, as a region targeted for calculation of the offset amount, a region on the main-view data in which an object image is to be overlaid, and generating an offset mask indicating the targeted region;
a feature point extraction step of limiting a search range to the targeted region indicated by the offset mask and a region near the targeted region, and extracting a predetermined number of feature points from the search range, each feature point being a characterizing pixel in the main-view data;
a first offset amount calculation step of calculating the offset amount for each of the feature points by performing a search for corresponding feature points in the sub-view data; and
a second offset amount calculation step of calculating the offset amount for each of pixels constituting the targeted region by using the offset amount calculated for each of the feature points.

34. A program for causing a computer to perform processing to calculate an offset amount in a horizontal direction between corresponding pixels in a set of main-view data and sub-view data constituting a stereoscopic video image, the program causing the computer to perform:
an offset mask generation step of specifying, as a region targeted for calculation of the offset amount, a region on the main-view data in which an object image is to be overlaid, and generating an offset mask indicating the targeted region;
a feature point extraction step of limiting a search range to the targeted region indicated by the offset mask and a region near the targeted region, and extracting a predetermined number of feature points from the search range, each feature point being a characterizing pixel in the main-view data;
a first offset amount calculation step of calculating the offset amount for each of the feature points by performing a search for corresponding feature points in the sub-view data; and
a second offset amount calculation step of calculating the offset amount for each of pixels constituting the targeted region by using the offset amount calculated for each of the feature points.
